(19) United States
(12) Patent Application Publication
(10) Pub. No.: US 2018/0264865 A1
(43) Pub. Date: Sep. 20, 2018

(54) IMAGE FORMATION SYSTEM, THREE-DIMENSIONAL IMAGE FORMATION SYSTEM, THREE-DIMENSIONAL IMAGE FORMATION METHOD, AND COMPUTER-READABLE STORAGE MEDIUM

(71) Applicant: CASIO COMPUTER CO., LTD., Tokyo (JP)

(72) Inventor: Yoshimune MOTOYANAGI, Tokyo (JP)

(73) Assignee: CASIO COMPUTER CO., LTD., Tokyo (JP)

(21) Appl. No.: 15/901,296

(22) Filed: Feb. 21, 2018

(30) Foreign Application Priority Data
Mar. 14, 2017 (JP) 2017-049175
Dec. 20, 2017 (JP) 2017-243502

(51) Int. Cl. B41M 7/00; B41J 2/01; B41M 5/00; B41J 11/00; B29C 44/02; B29C 44/60; B41J 3/407

(52) U.S. Cl. CPC B41M 7/0081; B41J 2/01; B41M 5/0047; B41M 5/0064; B29K 2105/256; B29C 44/022; B29C 44/60; B41J 3/407; B29C 2795/002; B41J 11/002

(57) ABSTRACT

An image formation system includes: a printer that prints an image on an expandable sheet; and a light irradiation device that performs a light irradiation process on the expandable sheet, to expand the expandable sheet corresponding to a print area of the image, wherein, before the light irradiation process, the printer prints an identifier including information relating to the image, on the expandable sheet.

### BACKGROUND OF THE INVENTION

### 1. Field of the Invention

The present invention relates to an image formation system, a three-dimensional image formation system, a three-dimensional image formation method, and a computer-readable storage medium.

### 2. Description of the Related Art

A three-dimensional image formation technique using an expandable sheet obtained by stacking a thermal expansion layer on a base material is known as one of the shaping techniques. For example, this technique is used in the production of teaching materials for the visually impaired such as braille. Japanese Patent Application Laid-Open No. S64-28660 (Patent Document 1) and Japanese Patent Application Laid-Open No. 2001-150812 (Patent Document 2) disclose techniques of printing, on an expandable sheet, a two-dimensional image (planar image) used when partially expanding a desired area, and performing a light irradiation process on the expandable sheet to expand the print area of the two-dimensional image and form a three-dimensional image.

Regarding the conventional techniques disclosed in Patent Documents 1 and 2, it is desirable that the expandable sheet carries information to be notified from a printer to a light irradiation device, as explained below.

A three-dimensional image formation system includes a printer that prints a two-dimensional image on an expandable sheet, and a light irradiation device that expands the print area of the two-dimensional image. Since ink used for printing has not sufficiently dried on the expandable sheet immediately after the printing, vaporization heat for vaporizing the ink is needed.

To form a three-dimensional image with a sufficient expansion height (i.e. to ensure the sufficient expansion height of the three-dimensional image), it is preferable to perform heat quantity adjustment control.

However, an operator of the three-dimensional image formation system occasionally performs an irregular operation. For example, suppose a regular procedure is to, after completing the three-dimensional image formation process (i.e. the process from the printing process to the light irradiation process) on one expandable sheet, perform the three-dimensional image formation process on the next expandable sheet. However, the operator might perform an irregular operation of, before completing the three-dimensional image formation process on one expandable sheet, starting the three-dimensional image formation process on the next expandable sheet. In detail, as an irregular operation, the operator might accumulate a plurality of expandable sheets that have undergone the printing process by the printer, and sequentially set the accumulated expandable sheets in the light irradiation device and perform the light irradiation process. If such an irregular operation is performed in the case where the above-mentioned heat quantity adjustment control is scheduled for an expandable sheet, heat quantity adjustment control will end up being performed on an expandable sheet different from the expandable sheet on which the heat quantity adjustment control is supposed to be performed. Thus, such an irregular operation makes it impossible to form a three-dimensional image with a sufficient expansion height (i.e. ensure the sufficient expansion height of the three-dimensional image).

Therefore, regarding the conventional techniques, it is desirable that the expandable sheet carries information (e.g. print-related information and other information) to be notified from the printer to the light irradiation device so that the above-mentioned heat quantity adjustment control can be appropriately carried out.

The present invention has an object of enabling an expandable sheet to carry information to be notified from a printer to a light irradiation device.

### SUMMARY OF THE INVENTION

An image formation system includes: a printer that prints an image on an expandable sheet; and a light irradiation device that performs a light irradiation process on the expandable sheet, to expand the expandable sheet corresponding to a print area of the image, wherein, before the light irradiation process, the printer prints an identifier including information relating to the image, on the expandable sheet.

A three-dimensional image formation system includes: a printer that prints a two-dimensional image on an expandable sheet; and a light irradiation device that performs a light irradiation process on the expandable sheet, to expand the expandable sheet corresponding to a print area of the two-dimensional image and form a three-dimensional image, wherein, before the light irradiation process, the printer prints an identifier including information relating to the two-dimensional image, on the expandable sheet.

A three-dimensional image formation method includes: a formation step of forming a two-dimensional image on an expandable sheet; and a light irradiation process step of performing a light irradiation process on the expandable sheet by a light irradiation device, to expand a print area of the two-dimensional image and form a three-dimensional object on the expandable sheet, wherein the formation step forms an identifier for controlling the light irradiation process and including information relating to the two-dimensional image, on the expandable sheet.

A computer-readable storage medium has stored therein a program executable by a computer, the program causing the computer that controls a three-dimensional image formation system for heating an expandable sheet to form a three-dimensional image, to perform: printing a two-dimensional image on the expandable sheet, and printing an identifier including information relating to the two-dimensional image on the expandable sheet; and controlling, after the identifier is printed, a light irradiation process by a light irradiation device based on the information relating to the two-dimensional image included in the identifier.

### BRIEF DESCRIPTION OF THE SEVERAL VIEWS OF THE DRAWING

FIG. 1 is a diagram illustrating the structure of a three-dimensional image formation system according to an embodiment.

FIG. 2 is a diagram illustrating the structure of a light irradiation device according to the embodiment.

FIGS. 3A and 3B are plan views illustrating the structure of an expandable sheet before a printing process.

FIGS. 4A and 4B are plan views illustrating the structure of the expandable sheet after the printing process.

FIGS. 5A to 5C are sectional views illustrating the structure of each site of the expandable sheet.

FIGS. 6A and 6B are sectional views (1) illustrating the structure of the expandable sheet before and after a light irradiation process.

FIGS. 7A and 7B are sectional views (2) illustrating the structure of the expandable sheet before and after the light irradiation process.

FIGS. 8A to 8D are diagrams illustrating a process example of the three-dimensional image formation system according to the embodiment.

FIG. 9 is a flowchart illustrating operation of the process example of the three-dimensional image formation system according to the embodiment.

FIGS. 10A to 10C are diagrams illustrating a first modified process example of the three-dimensional image formation system according to the embodiment.

FIG. 11 is a flowchart illustrating operation of the first modified process example of the three-dimensional image formation system according to the embodiment.

FIGS. 12A to 12F are diagrams illustrating a second modified process example of the three-dimensional image formation system according to the embodiment.

FIG. 13 is a flowchart illustrating operation of the second modified process example of the three-dimensional image formation system according to the embodiment.

FIGS. 14A to 14F are diagrams illustrating a third modified process example of the three-dimensional image formation system according to the embodiment.

FIG. 15 is a flowchart illustrating operation of the third modified process example of the three-dimensional image formation system according to the embodiment.

FIGS. 16A to 16F are diagrams illustrating a fourth modified process example of the three-dimensional image formation system according to the embodiment.

FIG. 17 is a flowchart illustrating operation of the fourth modified process example of the three-dimensional image formation system according to the embodiment.

FIG. 18 is a diagram illustrating an example of a corresponding process in the embodiment.

FIG. 19 is a diagram illustrating a modification of a barcode printed on the expandable sheet.

### DETAILED DESCRIPTION OF THE INVENTION

An embodiment (hereafter referred to as “this embodiment”) of the present invention is described in detail below, with reference to drawings. The drawings merely provide schematic depiction to facilitate the full understanding of the present invention, and the present invention is not limited only to the illustrated examples. In the drawings, the same or corresponding components are given the same reference signs, and their repeated description is omitted.

In this embodiment, “three-dimensional image” means a shaped object. The shaped object includes a wide range of shapes in general, such as simple shapes, geometric shapes, and characters. The shaped object also includes decorations formed as a result of decorating. A decoration evokes a sense of beauty through vision and/or touch. The term “three-dimensional image formation” means not only forming a shaped object but also decorating (forming a decoration).

### Embodiment

This embodiment is intended to provide a three-dimensional image formation system that can stably ensure a desired expansion height.

For example, in a three-dimensional image formation system, if a light irradiation process is performed in a state where ink has not sufficiently dried, a desired expansion height may be unable to be obtained. Various experiments conducted on this point have suggested that it is desirable to perform, in the light irradiation process, heat quantity adjustment control based on vaporization heat for vaporizing water contained in the ink to dry the ink. The three-dimensional image formation system according to this embodiment stably ensures the desired expansion height by performing such heat quantity adjustment control.

This embodiment relates to a method of forming a three-dimensional image (three-dimensional object or shaped object) by printing, on a medium (e.g. expandable sheet (thermal foaming sheet/distensible sheet)) having a thermal expansion layer (foaming layer) that expands (distends) according to the absorbed heat quantity on one side, a desired image with black ink including a material (e.g. electromagnetic wave-heat conversion material such as carbon) for converting an electromagnetic wave into heat, and expanding the site of the expansion layer where the image is formed on the medium by irradiation with an electromagnetic wave so as to rise outward.

<Structure of Three-Dimensional Image Formation System>

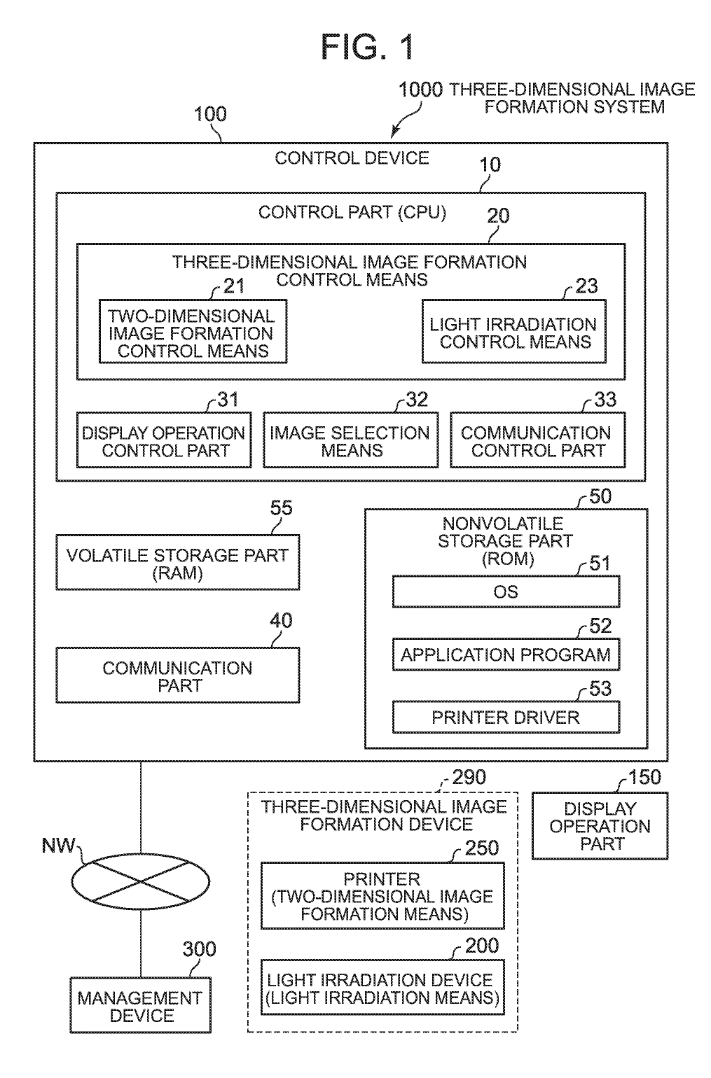

The structure of a three-dimensional image formation system 1000 according to this embodiment is described below, with reference to FIG. 1. FIG. 1 is a diagram illustrating the structure of the three-dimensional image formation system 1000 according to this embodiment.

As illustrated in FIG. 1, the three-dimensional image formation system 1000 includes a control device 100, a display operation part 150 connected to the control device 100, a light irradiation device (radiation device) 200, and a printer 250 as a two-dimensional image formation means. These components are communicably connected to a management device 300 via a network NW. The printer 250 and the light irradiation device 200 constitute a three-dimensional image formation device 290.

The control device 100 is a general-purpose information processing device composed of a personal computer (PC) and connected to the display operation part 150, and controls the light irradiation device 200 and the printer 250.

The display operation part 150 is a touch panel display connected to the control device 100, and includes a display means that displays a two-dimensional image and an input means that receives various information from the operator.

The light irradiation device 200 is a device that functions as a light irradiation means (irradiation means). The light irradiation device 200 forms an electromagnetic wave-heat conversion layer (hereafter simply referred to as “conversion layer”) for converting an electromagnetic wave into heat on the upper side (front side) and/or lower side (back side) of the expandable sheet, and applies an electromagnetic wave to cause the conversion layer to generate heat. The light irradiation device 200 thus performs the light irradiation process on the expandable sheet, to expand the print area of a two-dimensional image printed with the below-mentioned photothermal conversion ink and form a three-dimensional image.

The printer 250 is a device that functions as a two-dimensional image formation means. The printer 250 prints, on the expandable sheet, a two-dimensional image used when partially expanding a desired area, with the below-mentioned photothermal conversion ink. This embodiment assumes that the printer 250 is an inkjet printer, although the printer 250 may be an electrophotographic printer or the like.

The printer 250 performs printing using black ink, based on front side data indicating a portion to foam and expand on the front side of the expandable sheet. The printer 250 equally performs printing using black ink, based on back side data indicating a portion to foam and expand on the back side of the expandable sheet. Black ink including carbon black is an example of a material for converting electromagnetic wave light into heat. The material for converting an electromagnetic wave into heat may be another material. A portion where the density of black ink is higher has a greater expansion height of the thermal expansion layer. Hence, the density (gradation) of black ink is determined so as to correspond to a target height.

The management device 300 is a general-purpose information processing device, and stores and manages representative content used in three-dimensional image formation.

The control device 100 includes a control part 10, a communication part 40, a nonvolatile storage part 50, and a volatile storage part 55.

The control part 10 is a central processing unit (CPU), and executes a program to realize functions as a three-dimensional image formation control means 20, a display operation control part 31, an image selection means 32, and a communication control part 33.

The three-dimensional image formation control means 20 is a means that controls the operation of each part in the three-dimensional image formation process, and includes a two-dimensional image formation control means 21 and a light irradiation control means 23.

The two-dimensional image formation control means 21 is a functional part that controls the printer 250 via a printer driver 53.

The display operation control part 31 causes the display operation part 150 to display a predetermined screen, and receives a touch operation by the operator.

The image selection means 32, for example, causes the display operation part 150 to display a plurality of three-dimensional image contents (sample images), and requests the user to select one of the plurality of contents.

The communication control part 33 controls the communication part 40.

The communication part 40 is composed of a local area network (LAN) interface circuit, a universal serial bus (USB) interface circuit, or the like that performs communication with the light irradiation device 200, the printer 250, and the management device 300.

The nonvolatile storage part 50 is composed of read only memory (ROM), a hard disk drive (HDD), or the like, and stores an OS 51, an application program 52, a printer driver 53, and the like.

The volatile storage part 55 is composed of random access memory (RAM), and is used as working memory.

The photothermal conversion ink is ink having a property of converting light such as infrared light or near-infrared light into heat. In other words, the photothermal conversion ink is ink having a property of being easily heated when irradiated with light. The photothermal conversion ink is assumed here as black (K) ink including carbon black. However, the photothermal conversion ink may be another ink, instead of black ink including carbon black. For example, the photothermal conversion ink may be ink transparent in the visible light region, as long as it has a function of converting light such as infrared light or near-infrared light into heat.

The printer 250 can use ink (hereafter referred to as “non-photothermal conversion ink”) not having a property of converting light into heat, in addition to the photothermal conversion ink. The non-photothermal conversion ink is, for example, color ink of CMYK (cyan, magenta, yellow, black), and is used in the case of printing a color two-dimensional image. A print area with only the non-photothermal conversion ink hardly expands even when subjected to the light irradiation process.

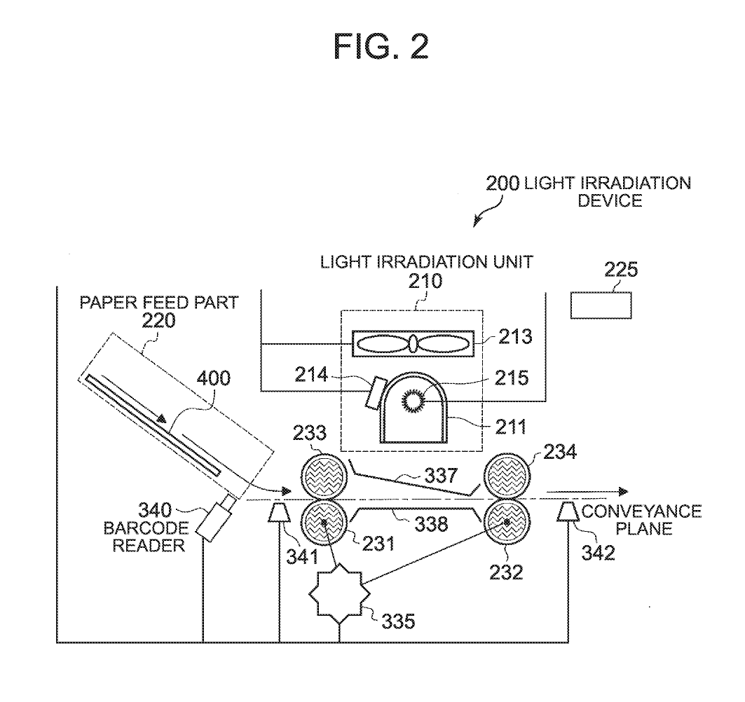

In such a structure, the printer 250 prints a two-dimensional image on an expandable sheet 400 (see FIG. 2) with the photothermal conversion ink, in order to partially expand a desired area of the expandable sheet 400. Moreover, in the case of printing a color two-dimensional image, the printer 250 prints the color two-dimensional image on the expandable sheet 400 with the non-photothermal conversion ink of CMYK (cyan, magenta, yellow, black) as an example.

The light irradiation device 200 performs the light irradiation process on the expandable sheet 400 (see FIG. 2) on which the two-dimensional image is printed.

<Structure of Light Irradiation Device>

The structure of the light irradiation device 200 is described below, with reference to FIG. 2. FIG. 2 is a diagram illustrating the structure of the light irradiation device 200.

As illustrated in FIG. 2, the light irradiation device 200 includes a paper feed part 220, drive rollers 231 and 232, driven rollers 233 and 234, a light irradiation unit 210, a motor 335, an upper guide 337, a lower guide 338, a room temperature sensor 225, a barcode reader 340, an entrance sensor 341, and an exit sensor 342. The paper feed part 220 feeds the expandable sheet 400 to the conveyance path. The drive rollers 231 and 232, the driven rollers 233 and 234, the motor 335, the upper guide 337, and the lower guide 338 constitute a conveyance unit (conveyance means).

The light irradiation unit (radiation unit) 210 includes a reflector 211, a halogen lamp 215, a cooling fan 213, and a temperature sensor 214. The halogen lamp 215 is a linear light source emitting near infrared light and visible light from its outer peripheral surface. The reflector 211 is a parabolic reflector made of aluminum, and collimates the radiation light of the halogen lamp 215. The halogen lamp 215 and the reflector 211 are located above the conveyance plane, so that light in the near infrared region and the visible light region (electromagnetic wave) is applied from above the expandable sheet 400. When the expandable sheet 400 printed with black ink including carbon black is irradiated with light, the light is converted into heat more efficiently in the portion printed with black ink than the portion not printed with black ink. Accordingly, the region printed with black ink (photothermal conversion ink) in the thermal expansion layer 410 is mainly heated, and as a result the thermal expansion layer 410 expands in the region printed with black ink.

The cooling fan 213 air-cools the reflector 211. The temperature sensor 214 is attached to the back of the reflector 211, and detects the temperature of the back of the reflector 211.

The drive rollers 231 and 232 and the driven rollers 233 and 234 convey the expandable sheet 400 being conveyed, by sandwiching it from above and below. The drive rollers 231 and 232 are driven by the motor 335. The upper guide 337 and the lower guide 338 are formed like a grid, and guide the expandable sheet 400 from above and below the conveyance plane. The upper guide 337 is inclined so as not to cast a dark shadow over the expandable sheet 400. Since the upper guide 337 and the expandable sheet 400 are away from each other by a predetermined distance directly below the halogen lamp 215, no dark shadow is cast over the expandable sheet 400.

The paper feed part 220 has the expandable sheet 400 placed therein, and feeds the placed expandable sheet 400 to the conveyance unit. The room temperature sensor 225 is a sensor for detecting the room temperature. The barcode reader 340 is a device for reading a barcode printed on the expandable sheet 400. The entrance sensor 341 and the exit sensor 342 detect the leading end and trailing end of the expandable sheet 400 being conveyed.

In such a structure, the light irradiation device 200 conveys the expandable sheet 400 printed with the two-dimensional image, in a state of lighting the halogen lamp 215. The light irradiation device 200 thus performs the light irradiation process on the expandable sheet 400. Here, the thermal expansion layer immediately below the print area printed with the two-dimensional image in the photothermal conversion ink expands in the expandable sheet 400, and the surface steeply changes in projecting shape. As a result, a three-dimensional image is formed. The three-dimensional image means a three-dimensional structure obtained by forming irregularities in the thickness direction on a plane.

<Structure of Expandable Sheet>

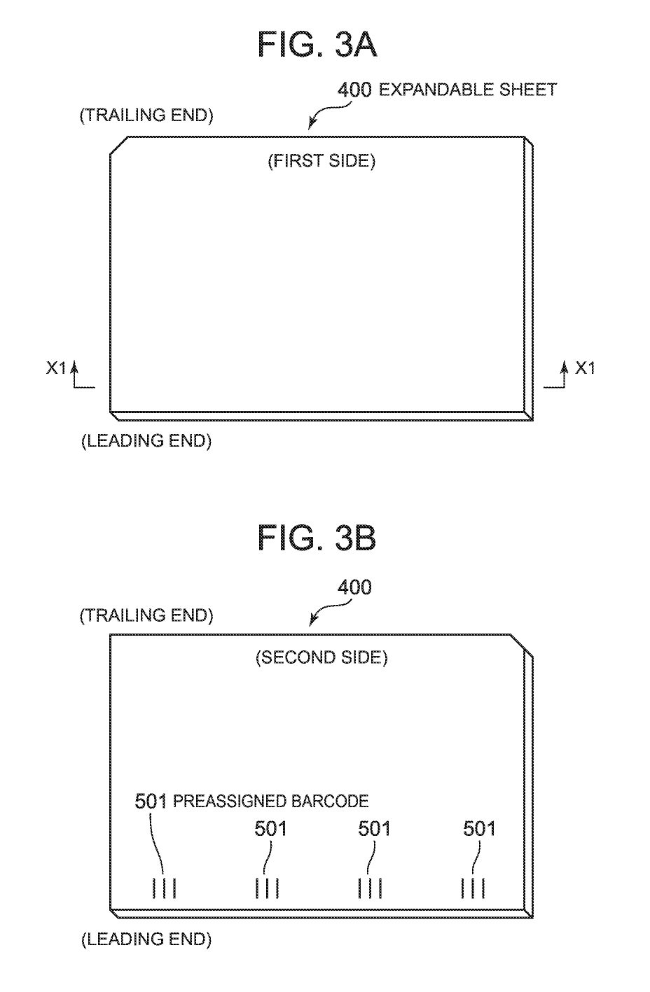

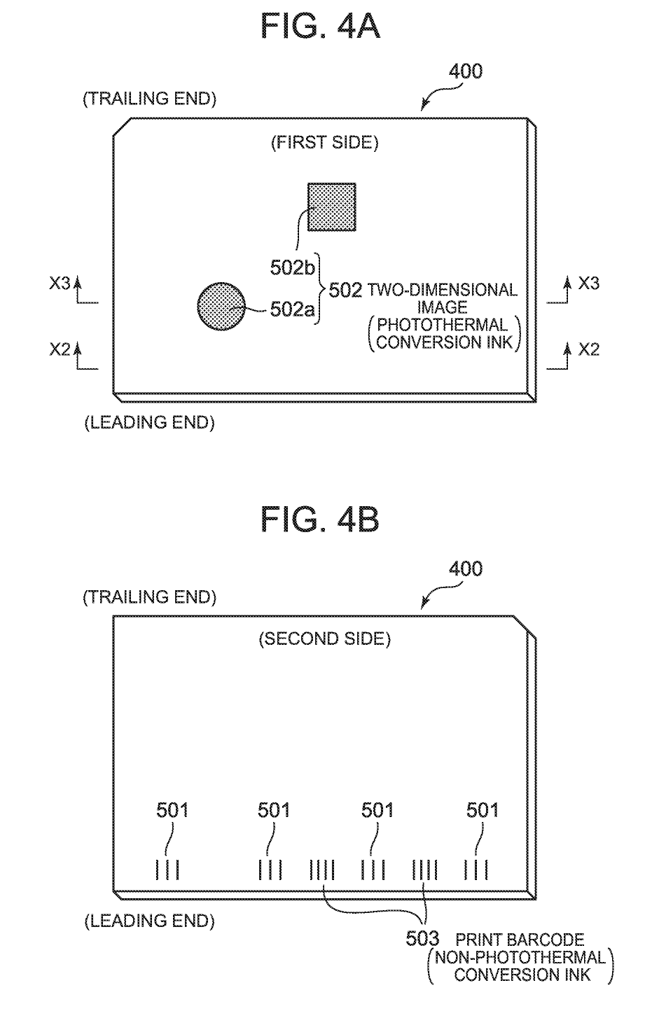

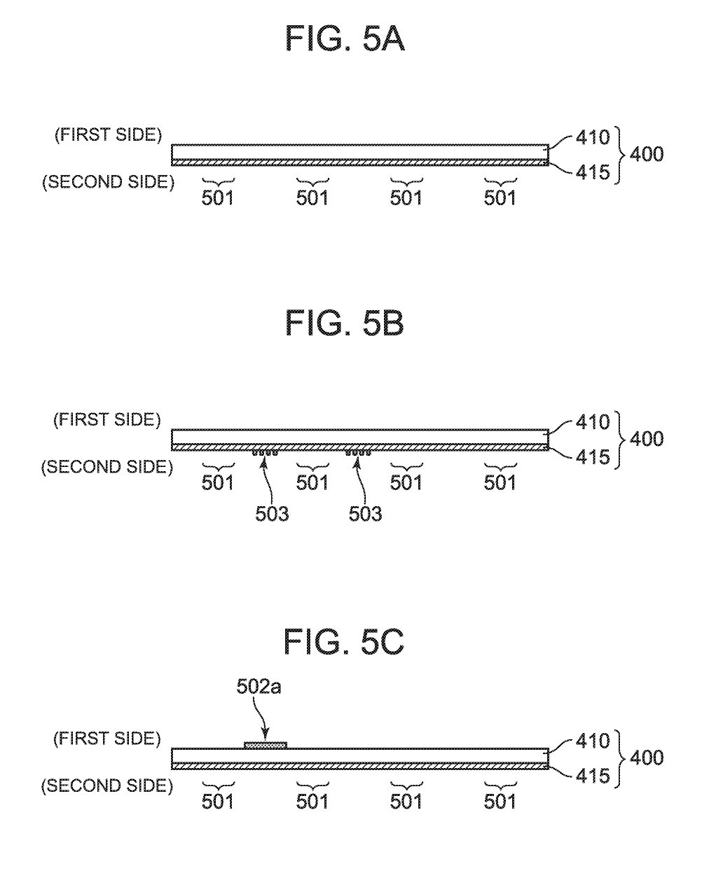

The structure of the expandable sheet 400 is described below, with reference to FIGS. 3A to 5C. FIGS. 3A and 3B are plan views illustrating the structure of the expandable sheet 400 before the printing process. FIGS. 4A and 4B are plan views illustrating the structure of the expandable sheet 400 after the printing process. FIGS. 3A and 3B respectively illustrate the structures of a first side and second side of the expandable sheet 400 before the printing process. FIGS. 4A and 4B respectively illustrate the structures of the first side and second side of the expandable sheet 400 after the printing process. FIGS. 5A to 5C are sectional views illustrating the structure of each site of the expandable sheet 400. FIG. 5A illustrates the shape of a section near the leading end of the expandable sheet 400 cut along line X1-X1 in FIG. 3A. FIG. 5B illustrates the shape of a section near the leading end of the expandable sheet 400 cut along line X2-X2 in FIG. 4A. FIG. 5C illustrates the shape of a section of the expandable sheet 400 cut along line X3-X3 in FIG. 4A so as to pass through the print area of a two-dimensional image 502a (see FIG. 4A).

It is assumed here that the side on which the thermal expansion layer 410 (see FIG. 5A) is located is the first side of the expandable sheet 400, and the side on which a base material 415 (see FIG. 5A) is located is the second side of the expandable sheet 400.

Irregularities are formed on the front side of the expandable sheet 400, by the printer 250 performing printing to cause the thermal expansion layer 410 of the expandable sheet 400 to expand and rise outward. Such raised parts (bumps) of the thermal expansion layer 410 form projections, or projections and depressions. Thus, a three-dimensional image (three-dimensional object or shaped object) is formed on the expandable sheet 400.

The expandable sheet 400 has a rectangular shape with one corner portion being cut away, as illustrated in FIG. 3A. Before the printing process, the first side of the expandable sheet 400 is in a blank state. Moreover, before the printing process, a preassigned barcode 501 is printed beforehand near the leading end on the second side of the expandable sheet 400 depending on operation, as illustrated in FIG. 3B. The preassigned barcode 501 is a pre-identifier assigned beforehand. It is assumed here that the side inserted into the paper feed part 220 (see FIG. 2) of the light irradiation device 200 is the leading end of the expandable sheet 400. The preassigned barcode 501 may not be printed.

In the printing process, a two-dimensional image 502 is printed on the first side of the expandable sheet 400 with the photothermal conversion ink by the printer 250 (see FIG. 1), as illustrated in FIG. 4A. A circular two-dimensional image 502a and a square two-dimensional image 502b are printed in the illustrated example. Moreover, in the printing process, a barcode 503 different from the preassigned barcode 501 is printed on the second side of the expandable sheet 400 with the non-photothermal conversion ink by the printer 250 (see FIG. 1), as illustrated in FIG. 4B. The barcode 503 is a print identifier printed later. The barcode 503 is hereafter referred to as “print barcode 503” when distinguishing it from the preassigned barcode 501.

The preassigned barcode 501 indicates the attribute of the expandable sheet 400 (e.g. the thickness of the sheet, the orientation of the front side or back side of the sheet, etc.). The print barcode 503 includes any information set depending on operation. For example, the print barcode 503 may include print area information of the two-dimensional image 502, print time information of the two-dimensional image 502, heat quantity adjustment control correction information for the irradiation condition of light applied to the sheet (the conveyance speed of the expandable sheet 400, the quantity of light applied to the expandable sheet 400, etc.), and the like.

The expandable sheet 400 has a structure of stacking the base material 415 and the thermal expansion layer 410, as illustrated in FIG. 5A. In this embodiment, the expandable sheet 400 has the thermal expansion layer 410 on one side (first side), and the base material 415 on the other side (second side). The base material 415 is an elastically deformable paper sheet. The thermal expansion layer 410 is a resin layer that expands by heat. The thermal expansion layer 410 is formed on one side (upper side in FIG. 5) of the base material 415. The thermal expansion layer 410 is a layer that expands to such an extent that corresponds to the heating temperature and the heating time, and has a plurality of pieces of thermal expansion material (thermally expandable microcapsule, micropowder) dispersed in a binder. In this embodiment, the two-dimensional image 502a (hereafter simply referred to as “conversion layer”) which is an electromagnetic wave-heat conversion layer for converting an electromagnetic wave into heat is formed on the upper side (front side) of the base material 415 and/or the lower side (back side) of the base material 415 and irradiated with light, to cause heat generation in the area provided with the two-dimensional image 502a which is the conversion layer. The two-dimensional image 502a which is the conversion layer is heated when irradiated with an electromagnetic wave. The thermal expansion layer 410 absorbs the heat generated by the conversion layer provided on the front side and/or back side of the expandable sheet 400, to foam and expand. This enables selective expansion of only a specific area of the expandable sheet 400. For example, the thermal expansion material foams and expands when heated to a temperature of about 80° C. to 120° C.

Before the printing process, the preassigned barcode 501 has been printed beforehand near the leading end on the second side of the expandable sheet 400, as illustrated in FIG. 5A.

After the printing process, the print barcode 503 different from the preassigned barcode 501 has been printed near the leading end on the second side of the expandable sheet 400, as illustrated in FIG. 5B. Moreover, after the printing process, the two-dimensional image 502 has been printed at a given position on the first side of the expandable sheet 400, as illustrated in FIG. 5C.

<Structure of Three-Dimensional Image>

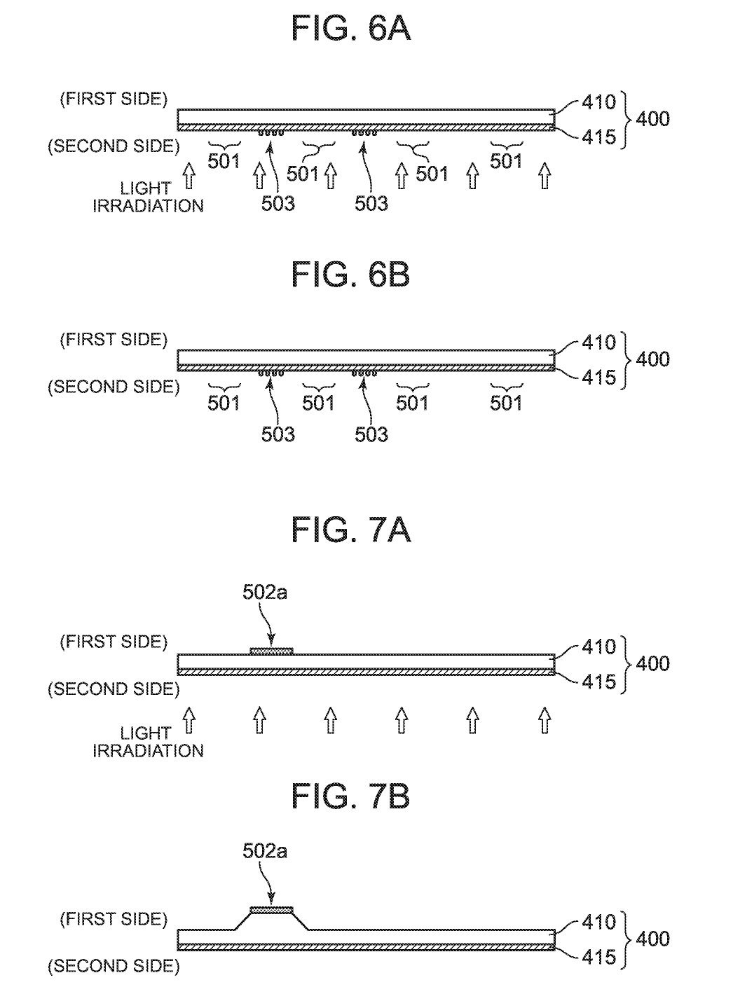

The structure of a three-dimensional image is described below, with reference to FIGS. 6A to 7B. FIGS. 6A to 7B are sectional views illustrating the structure of the expandable sheet 400 before and after the light irradiation process. FIGS. 6A and 6B illustrate the shape of a section near the leading end of the expandable sheet 400 cut along line X2-X2 in FIG. 4A, before and after the light irradiation process. FIGS. 7A and 7B illustrate the shape of a section of the expandable sheet 400 cut along line X3-X3 in FIG. 4A so as to pass through the print area of the two-dimensional image 502a (see FIG. 4A), before and after the light irradiation process.

The light irradiation device 200 (see FIG. 1) performs the light irradiation process by irradiating the second side of the expandable sheet 400 with light such as infrared light or near-infrared light, as illustrated in FIG. 6A. Here, since the photothermal conversion ink is not used near the leading end of the expandable sheet 400, this part is hardly heated. Accordingly, after the light irradiation process, no three-dimensional image has been formed near the leading end of the expandable sheet 400, and the vicinity of the leading end of the expandable sheet 400 maintains the same sectional shape as that before the light irradiation process, as illustrated in FIG. 6B.

On the other hand, when the light irradiation device 200 (see FIG. 1) performs the light irradiation process by irradiating the second side of the expandable sheet 400 with light as illustrated in FIG. 7A, the print area of the two-dimensional image 502a of the expandable sheet 400 is heated. Hence, after the light irradiation process, the expandable sheet 400 has expanded immediately below the print area of the two-dimensional image 502a and as a result a three-dimensional image has been formed, as illustrated in FIG. 7B.

<Operation of Three-Dimensional Image Formation System>

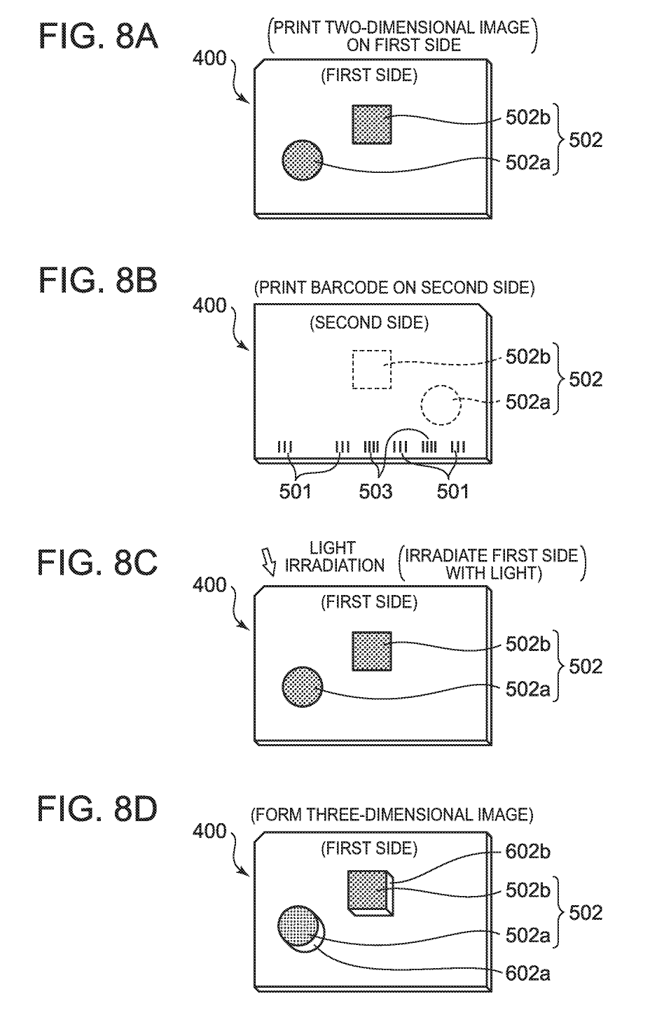

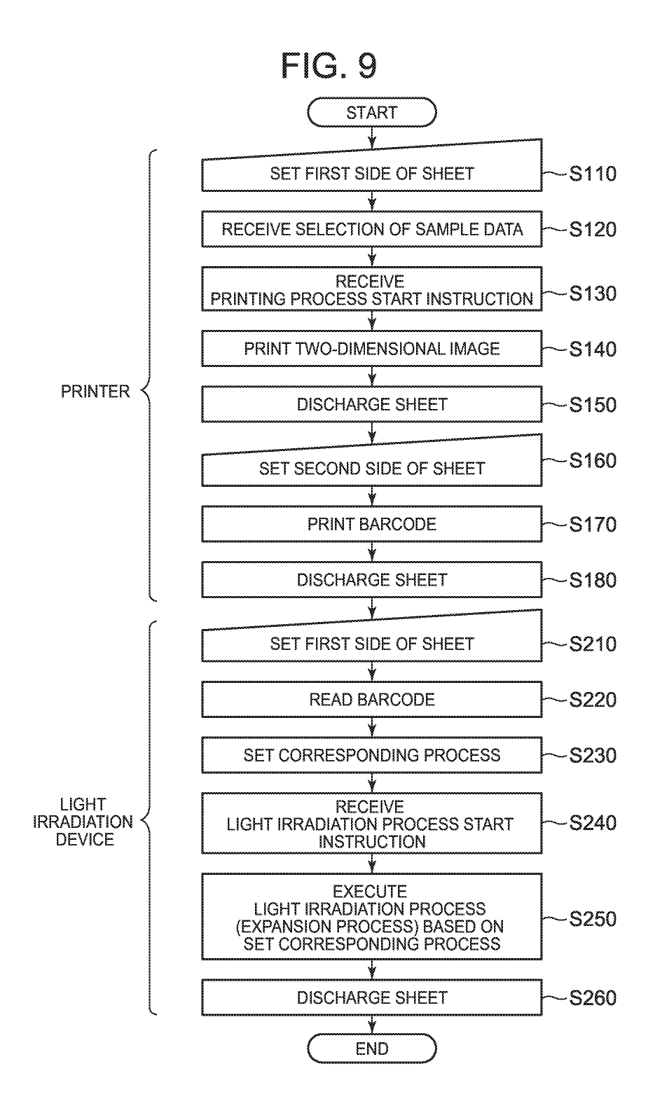

The operation of the three-dimensional image formation system 1000 is described below, with reference to FIGS. 8A to 9. FIGS. 8A to 8D are diagrams illustrating a process example of the three-dimensional image formation system 1000. FIG. 9 is a flowchart illustrating operation of the process example of the three-dimensional image formation system 1000. In FIG. 9, each trapezoidal frame part represents operation performed by the operator (the same applies hereafter).

Each device operates based on time measured by a timer (not illustrated). The operation of each device is defined by a program readably stored beforehand in a storage part of the device, and executed by a control part of the device. Since these are common means in information processing, their detailed description is omitted.

In this embodiment, it is assumed that the light irradiation device 200 performs heat quantity adjustment control depending on the photothermal conversion ink accumulation density per one sheet in the printing of the two-dimensional image 502, although the light irradiation device 200 may perform heat quantity adjustment control depending on the photothermal conversion ink accumulation density per desired area in the conveyance direction of the expandable sheet 400 in the printing of the two-dimensional image 502.

The process example illustrated in FIGS. 8A to 8D indicates that the three-dimensional image formation system 1000 preforms the following processes a to d.

(Process a): print the two-dimensional image (the two two-dimensional images 502a and 502b in the illustrated example) on the first side (see FIG. 8A).

(Process b): print the print barcode 503 on the second side (see FIG. 8B). The print barcode 503 includes information relating to the two two-dimensional images 502a and 502b.

(Process c): irradiate the first side with light (see FIG. 8C).

(Process d): form the three-dimensional image (three-dimensional images 602a and 602b corresponding to the two two-dimensional images 502a and 502b in the illustrated example) (see FIG. 8D).

The process example illustrated in FIGS. 8A to 8D is realized by the three-dimensional image formation system 1000 executing each process in the flowchart in FIG. 9.

As illustrated in FIG. 9, in the three-dimensional image formation system 1000, the operator sets the first side of the expandable sheet 400 in a paper feed part (not illustrated) of the printer 250 so that the first side of the expandable sheet 400 is printed (step S110). The printer 250, upon detecting the setting of the expandable sheet 400, sends the detection information to the control device 100. In response to this, the control device 100, for example, displays a content list display screen (not illustrated) on the display operation part 150 (see FIG. 1).

After step S110, the operator operates the display operation part 150 (see FIG. 1), to select desired content (sample image) from the content list display screen (not illustrated), and issue a printing process start instruction. The control device 100 responsively receives the sample image data selection result, and receives the printing process start instruction (steps S120 and S130).

The two-dimensional image formation control means 21 (see FIG. 1) in the control device 100 instructs the printer 250 to print a two-dimensional image based on the selected sample image data. The printer 250 responsively prints the two-dimensional image 502 (see FIG. 4A) on the first side of the expandable sheet 400 with the photothermal conversion ink (step S140). After the printing is completed, the printer 250 discharges the expandable sheet 400 (step S150).

The operator turns the discharged expandable sheet 400 over, and sets the second side of the expandable sheet 400 in the paper feed part (not illustrated) of the printer 250 so that the second side of the expandable sheet 400 is printed (step S160). The printer 250, upon detecting the setting of the expandable sheet 400, sends the detection information to the control device 100. The two-dimensional image formation control means 21 (see FIG. 1) in the control device 100 responsively instructs the printer 250 to print the print barcode 503 (see FIG. 4B). The printer 250 responsively prints the print barcode 503 (see FIG. 4B) on the expandable sheet 400 with the non-photothermal conversion ink (see FIG. 4B) (step S170). After the printing is completed, the printer 250 discharges the expandable sheet 400 (step S180). Details of the information included in the print barcode 503 (see FIG. 4B) will be described later in “example of corresponding process in this embodiment”.

After step S180, the operator sets the first side of the expandable sheet 400 in the paper feed part 220 (see FIG. 2) of the light irradiation device 200 so that the first side of the expandable sheet 400 discharged is irradiated with light (step S210).

The light irradiation device 200, upon detecting the setting of the expandable sheet 400, reads the print barcode 503 (see FIG. 4B) of the expandable sheet 400 by the barcode reader 340 (see FIG. 2) (step S220), and sends the barcode read information to the control device 100. The light irradiation control means 23 (see FIG. 1) in the control device 100 sets a corresponding process based on the barcode read information (step S230). Details of the corresponding process will be described later in “example of corresponding process in this embodiment”.

The operator operates the display operation part 150 (see FIG. 1) to instruct the control device 100 to start the light irradiation process. The control device 100 responsively receives the light irradiation process start instruction (step S240).

The light irradiation control means 23 (see FIG. 1) in the control device 100 causes the light irradiation device 200 to execute the light irradiation process (expansion process) based on the set corresponding process (step S250). As a result, a three-dimensional image is formed on the expandable sheet 400. After the light irradiation process (expansion process) ends, the light irradiation device 200 discharges the expandable sheet 400 (step S260).

The side on which the two-dimensional image 502 or the print barcode 503 is printed may be changed depending on operation. The processes executed by the three-dimensional image formation system 1000 are responsively changed as appropriate. An example of this is described below.

It is assumed here that the barcode reader 340 (see FIG. 2) has a function of reading the preassigned barcode 501 and the print barcode 503 from both sides (i.e. both of the first and second sides) of the expandable sheet 400.

### First Modified Process Example

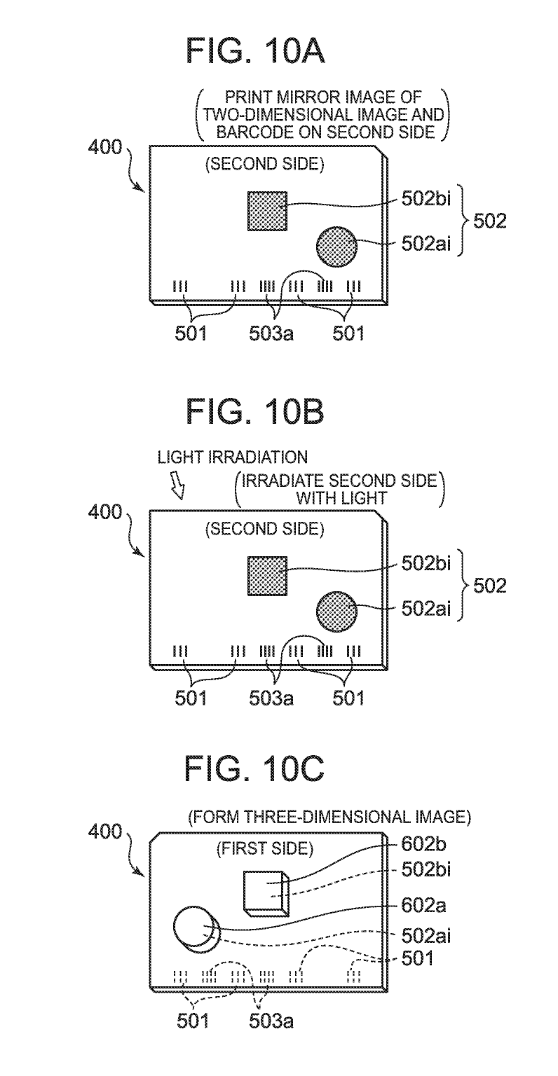

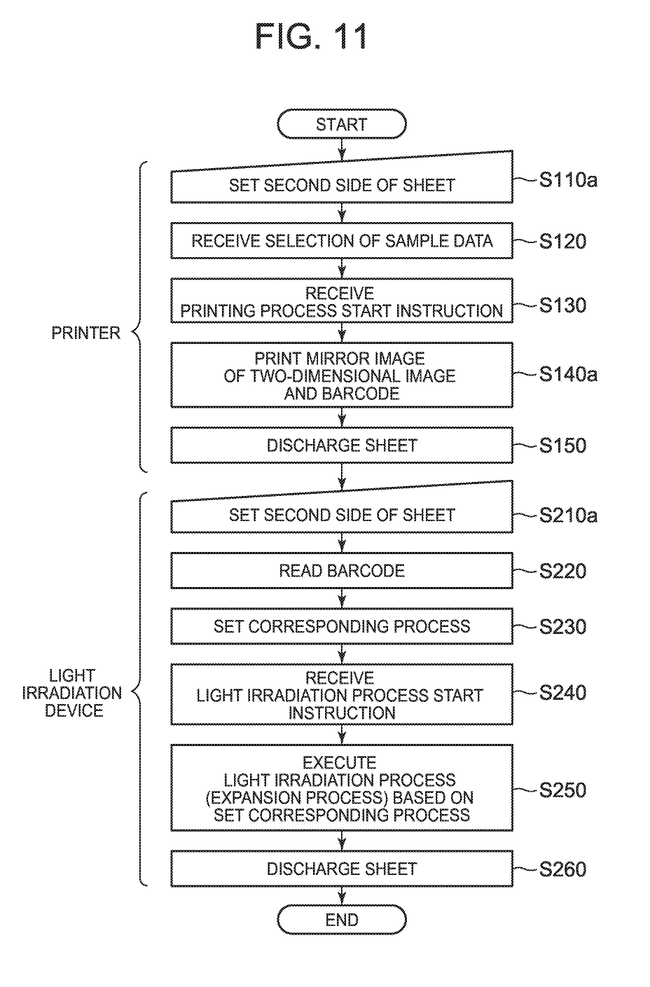

A first modified process example is described below, with reference to FIGS. 10A to 11. FIGS. 10A to 10C are diagrams illustrating the first modified process example. FIG. 11 is a flowchart illustrating operation of the first modified process example.

The first modified process example illustrated in FIGS. 10A to 10C indicates that the three-dimensional image formation system 1000 preforms the following processes 1a to 1c.

(Process 1a): print a mirror image (mirror images 502ai and 502bi of the two two-dimensional images in the illustrated example) of the two-dimensional image and the print barcode 503a relating to the second side, on the second side (see FIG. 10A). The print barcode 503a relating to the second side includes information relating to the mirror images 502ai and 502bi of the two two-dimensional images printed on the second side of the expandable sheet 400.

(Process 1b): irradiate the second side with light (see FIG. 10B).

(Process 1c): form the three-dimensional image (three-dimensional images 602a and 602b corresponding to the mirror images 502ai and 502bi of the two two-dimensional images in the illustrated example) (see FIG. 10C).

The first modified process example illustrated in FIGS. 10A to 10C is realized by the three-dimensional image formation system 1000 executing each process in the flowchart in FIG. 11.

As illustrated in FIG. 11, the first modified process example differs from the above-mentioned process example (see FIG. 9) in the following points.

(Difference 1): the process of step S110a is performed instead of the process of step S110 (see FIG. 9).

(Difference 2): the process of step S140a is performed instead of the process of step S140 (see FIG. 9).

(Difference 3): the processes of steps S160 to S180 (see FIG. 9) are not performed.

(Difference 4): the process of step S210a is performed instead of the process of step S210 (see FIG. 9).

(Regarding Difference 1)

The process of step S110a is a process in which the operator sets the second side of the expandable sheet 400 in the paper feed part (not illustrated) of the printer 250 so that the second side of the expandable sheet 400 is printed.

(Regarding Difference 2)

The process of step S140a is a process of printing the mirror image (the mirror images 502ai and 502bi of the two two-dimensional images in the illustrated example) of the two-dimensional image with the photothermal conversion ink and the print barcode 503a relating to the second side on the second side of the expandable sheet 400. The print barcode 503a relating to the second side includes information relating to the mirror images 502ai and 502bi of the two two-dimensional images printed on the second side of the expandable sheet 400, as mentioned above.

(Regarding Difference 3)

In the first modified process example, since all of the mirror image of the two-dimensional image and the print barcode 503a relating to the second side are printed on the second side of the expandable sheet 400 in step S140a, the processes of steps S160 to S180 (see FIG. 9) are omitted.

(Regarding Difference 4)

The process of step S110a is a process in which the operator sets the second side of the expandable sheet 400 in the paper feed part 220 (see FIG. 2) of the light irradiation device 200 so that the second side of the expandable sheet 400 is irradiated with light.

In the first modified process example, the operator sets the second side of the expandable sheet 400 in the paper feed part (not illustrated) of the printer 250 so that the second side of the expandable sheet 400 is printed (step S110a). The printer 250 then executes the processes of steps S120 to S150. In step S140a, the printer 250 simultaneously prints all of the mirror image (the mirror images 502ai and 502bi of the two two-dimensional images in the illustrated example) of the two-dimensional image and the print barcode 503a relating to the second side, on the second side of the expandable sheet 400.

After step S150, in step S210a, the operator sets the second side of the expandable sheet 400 in the paper feed part 220 of the light irradiation device 200 so that the second side of the expandable sheet 400 is irradiated with light. The light irradiation device 200 then executes the processes of steps S220 to S260.

### Second Modified Process Example

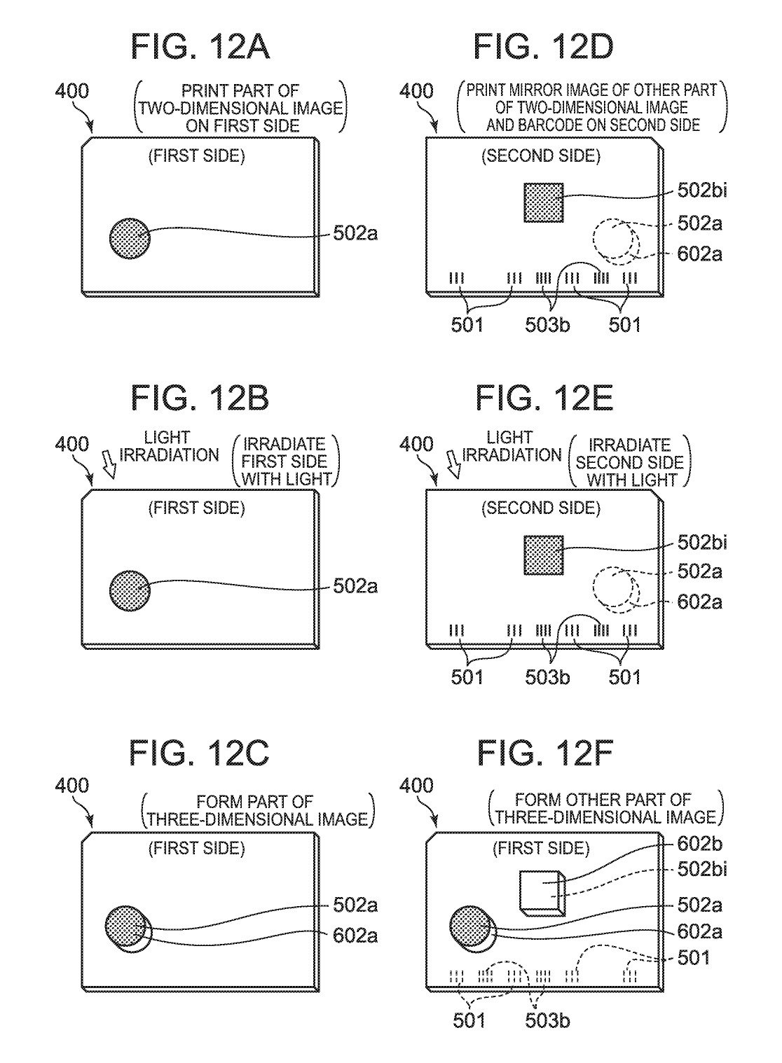

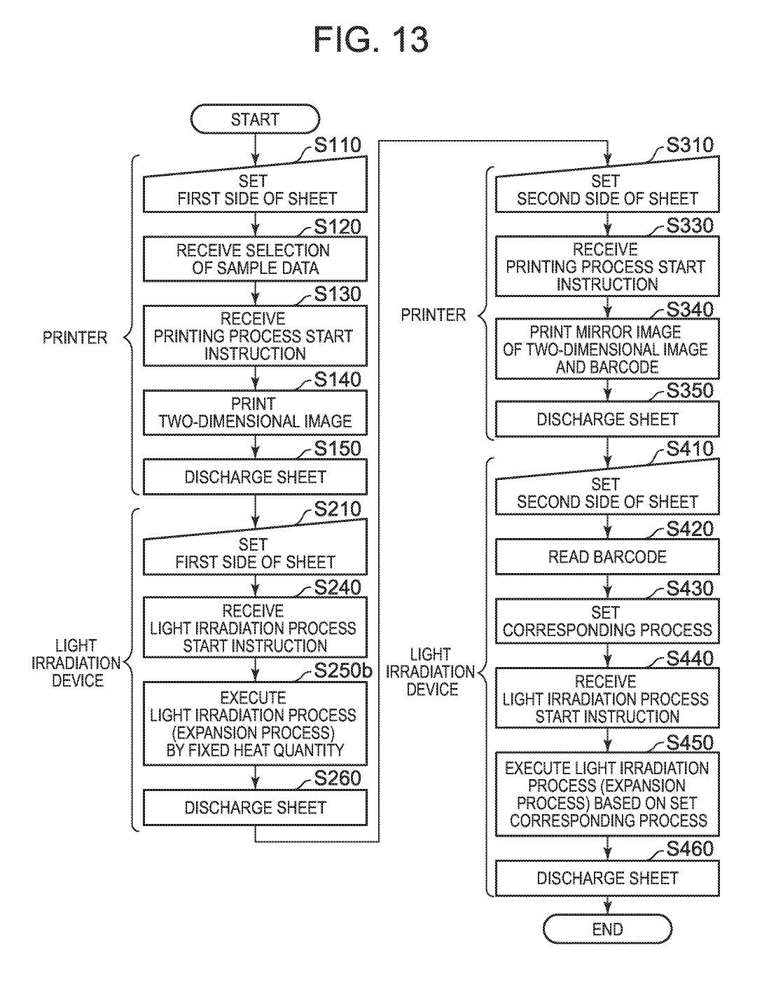

A second modified process example is described below, with reference to FIGS. 12A to 13. FIGS. 12A to 12F are diagrams illustrating the second modified process example. FIG. 13 is a flowchart illustrating operation of the second modified process example.

The second modified process example illustrated in FIGS. 12A to 12F indicates that the three-dimensional image formation system 1000 preforms the following processes 2a to 2f.

(Process 2a): print part (the two-dimensional image 502a in the illustrated example) of the two-dimensional image on the first side (see FIG. 12A).

(Process 2b): irradiate the first side with light (see FIG. 12B).

(Process 2c): form part (the three-dimensional image 602a corresponding to the two-dimensional image 502a) of the three-dimensional image (see FIG. 12C).

(Process 2d): print the mirror image (the mirror image 502bi in the illustrated example) of the two-dimensional image (hereafter referred to as “other part of the two-dimensional image”) other than the two-dimensional image 502a and a print barcode 503b relating to the second side, on the second side (see FIG. 12D). The print barcode 503b relating to the second side includes information relating to the mirror image 502bi of the other part of the two-dimensional image printed on the second side of the expandable sheet 400.

(Process 2e): irradiate the second side with light (see FIG. 12E).

(Process 2f): form the other part (the three-dimensional image 602b corresponding to the mirror image 502bi of the other part of the two-dimensional image in the illustrated example) of the three-dimensional image (see FIG. 12F).

The second modified process example illustrated in FIGS. 12A to 12F is realized by the three-dimensional image formation system 1000 executing each process in the flowchart in FIG. 13.

As illustrated in FIG. 13, the second modified process example differs from the above-mentioned process example (see FIG. 9) in the following points.

(Difference 1): the processes of steps S160 to S180 (see FIG. 9) are not performed.

(Difference 2): the processes of steps S220 to S230 (see FIG. 9) are not performed.

(Difference 3): the process of step S250b is performed instead of the process of step S250 (see FIG. 9).

(Difference 4): the processes of steps S310 to S460 are performed after step S260.

(Regarding Difference 1)

In the second modified process example, since the two-dimensional image 502a printed on the first side of the expandable sheet 400 in step S140 is irradiated with light, the processes of steps S160 to S180 (see FIG. 9) are omitted.

(Regarding Difference 2)

In the second modified process example, since the print barcode 503b is not printed on the first side of the expandable sheet 400, the processes of steps S220 to S230 (see FIG. 9) are omitted.

(Regarding Difference 3)

The process of step S250b is a process in which the light irradiation control means 23 (see FIG. 1) in the control device 100 causes the light irradiation device 200 to execute the light irradiation process (expansion process) by fixed heat quantity.

(Regarding Difference 4)

The processes of steps S310 to S460 are as follows.

After step S260, the operator sets the second side of the expandable sheet 400 in the paper feed part (not illustrated) of the printer 250 so that the second side of the expandable sheet 400 is printed (step S310). In the second modified process example, in step S260, the three-dimensional image 602a corresponding to the two-dimensional image 502a has been formed on the first side of the expandable sheet 400 (see FIG. 12C).

The printer 250, upon detecting the setting of the expandable sheet 400, sends the detection information to the control device 100. In response to this, the control device 100, for example, displays a content list display screen (not illustrated) on the display operation part 150 (see FIG. 1).

The operator operates the display operation part 150 (see FIG. 1), to issue a printing process start instruction. The control device 100 responsively receives the printing process start instruction (step S330).

The two-dimensional image formation control means 21 (see FIG. 1) in the control device 100 instructs the printer 250 to print the mirror image (the mirror image 502bi (see FIG. 12D) in the illustrated example) of the other part of the two-dimensional image. The printer 250 responsively prints the mirror image (the mirror image 502bi (see FIG. 12D) in the illustrated example) of the other part of the two-dimensional image on the second side of the expandable sheet 400 with the photothermal conversion ink (step S340). After the printing is completed, the printer 250 discharges the expandable sheet 400 (step S350).

After step S350, the operator sets the second side of the expandable sheet 400 in the paper feed part 220 (see FIG. 2) of the light irradiation device 200 so that the second side of the expandable sheet 400 discharged is irradiated with light (step S410). The light irradiation device 200, upon detecting the setting of the expandable sheet 400, reads the print barcode 503b (see FIG. 12D) of the expandable sheet 400 by the barcode reader 340 (see FIG. 2) (step S420), and sends the barcode read information to the control device 100. The light irradiation control means 23 (see FIG. 1) in the control device 100 sets a corresponding process for the second side of the expandable sheet 400 based on the barcode read information (step S430). The control device 100 displays an operation screen (not illustrated) of the light irradiation device 200 on the display operation part 150 (see FIG. 1). Details of the corresponding process will be described later in “example of corresponding process in this embodiment”.

The operator operates the display operation part 150 (see FIG. 1) to instruct the control device 100 to start the light irradiation process. The control device 100 responsively receives the light irradiation process start instruction (step S440).

The light irradiation control means 23 (see FIG. 1) in the control device 100 causes the light irradiation device 200 to execute the light irradiation process (expansion process) based on the set corresponding process, on the second side of the expandable sheet 400 (step S450). As a result, the light irradiation device 200 forms the three-dimensional image 602b corresponding to the mirror image 502bi of the other part of the two-dimensional image, on the first side of the expandable sheet 400 (see FIG. 12F). After the light irradiation process (expansion process) ends, the light irradiation device 200 discharges the expandable sheet 400 (step S460).

In the second modified process example, the operator first sets the first side of the expandable sheet 400 in the paper feed part (not illustrated) of the printer 250 so that the first side of the expandable sheet 400 is printed (step S110). The printer 250 then executes the processes of steps S120 to S150. In step S140, the printer 250 prints the two-dimensional image 502a on the first side of the expandable sheet 400 (see FIG. 12A).

After step S150, the operator sets the first side of the expandable sheet 400 in the paper feed part 220 of the light irradiation device 200 so that the first side of the expandable sheet 400 is irradiated with light. The light irradiation device 200 then executes the processes of steps S210, S240, S250b, and S260. In step S250b, the light irradiation device 200 performs the light irradiation process (expansion process) by the fixed heat quantity, on the first side of the expandable sheet 400 (see FIG. 12B). The light irradiation device 200 thus forms the three-dimensional image 602a corresponding to the two-dimensional image 502a on the first side of the expandable sheet 400 (see FIG. 12C).

After step S260, the operator turns the expandable sheet 400 over, and sets the second side of the expandable sheet 400 in the paper feed part (not illustrated) of the printer 250 so that the second side of the expandable sheet 400 is printed (step S310). The printer 250 then executes the processes of steps S310, S330, S340, and S350. In step S340, the printer 250 simultaneously prints the mirror image 502bi of the other part of the two-dimensional image and the print barcode 503b relating to the second side, on the second side of the expandable sheet 400.

After step S350, the operator sets the second side of the expandable sheet 400 in the paper feed part 220 of the light irradiation device 200 so that the second side of the expandable sheet 400 is irradiated with light (step S410). The light irradiation device 200 then executes the processes of steps S410 to S460. In steps S420 and S430, the light irradiation device 200 reads the print barcode 503b relating to the second side (see FIG. 12D), and sets the corresponding process for the second side of the expandable sheet 400 based on the read information. In step S450, the light irradiation device 200 performs the light irradiation process (expansion process) based on the set corresponding process, on the second side of the expandable sheet 400 (see FIG. 12E). The light irradiation device 200 thus forms the three-dimensional image 602b corresponding to the mirror image 502bi of the other part of the two-dimensional image, on the first side of the expandable sheet 400 (see FIG. 12F).

### Third Modified Process Example

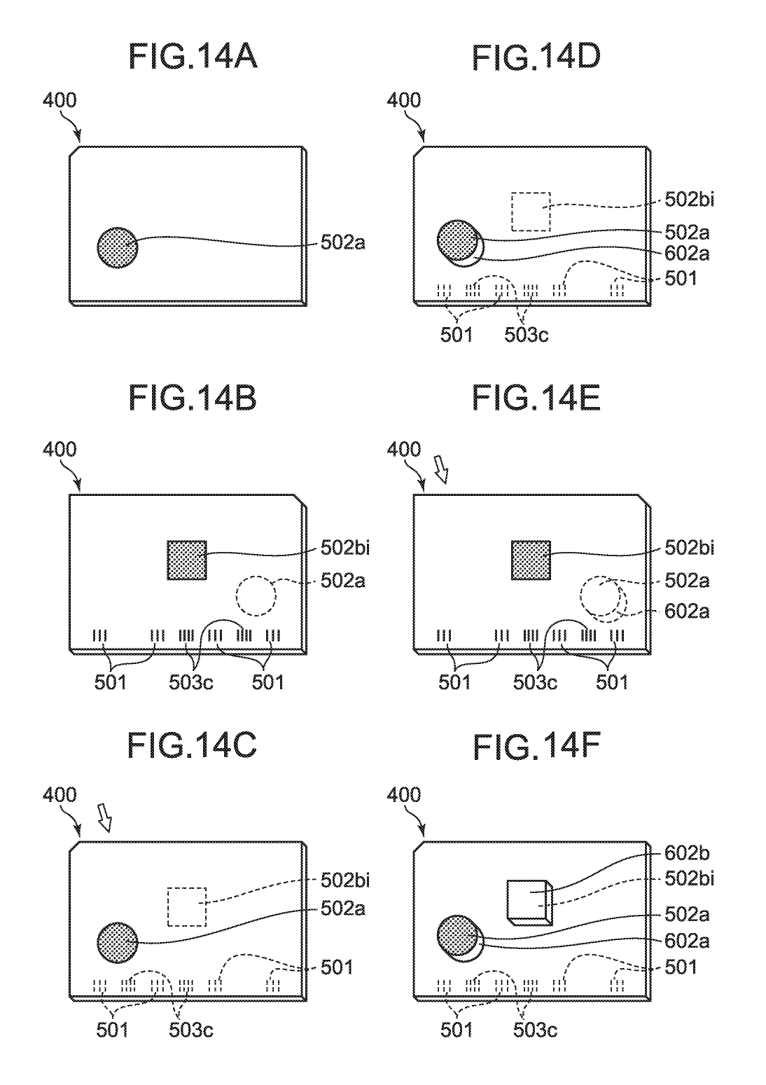

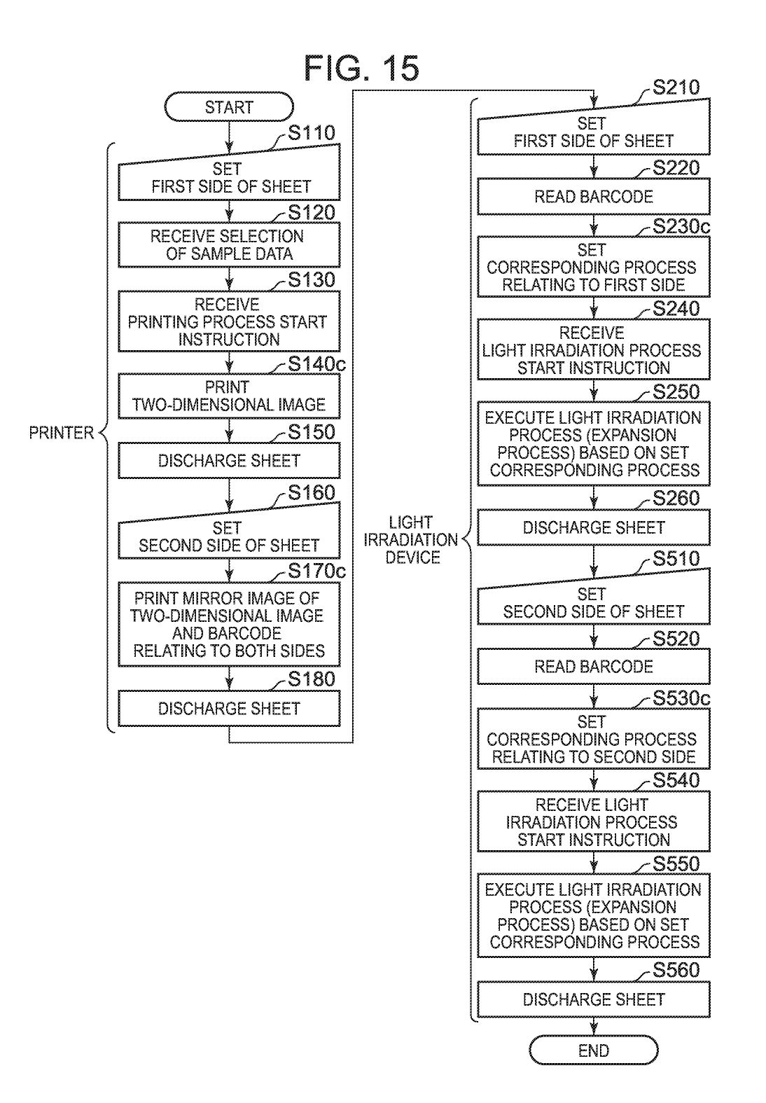

A third modified process example is described below, with reference to FIGS. 14A to 15. FIGS. 14A to 14F are diagrams illustrating the third modified process example. FIG. 15 is a flowchart illustrating operation of the third modified process example.

The third modified process example illustrated in FIGS. 14A to 14F indicates that the three-dimensional image formation system 1000 preforms the following processes 3a to 3f.

(Process 3a): print part (the two-dimensional image 502a in the illustrated example) of the two-dimensional image on the first side (see FIG. 14A).

(Process 3b): print the mirror image (the mirror image 502bi in the illustrated example) of the other part of the two-dimensional image and a print barcode 503c relating to both sides, on the second side (see FIG. 14B). The print barcode 503c relating to both sides includes information relating to the two-dimensional image 502a and the mirror image 502bi of the other part of the two-dimensional image printed on both sides (i.e. the first and second sides) of the expandable sheet 400.

(Process 3c): irradiate the first side with light (see FIG. 14C).

(Process 3d): form part (the three-dimensional image 602a corresponding to the two-dimensional image 502a in the illustrated example) of the three-dimensional image (see FIG. 14D).

(Process 3e): irradiate the second side with light (see FIG. 14E).

(Process 3f): form the other part (the three-dimensional image 602b corresponding to the mirror image 502bi of the other part of the two-dimensional image in the illustrated example) of the three-dimensional image (see FIG. 14F).

The third modified process example illustrated in FIGS. 14A to 14F is realized by the three-dimensional image formation system 1000 executing each process in the flowchart in FIG. 15.

As illustrated in FIG. 15, the third modified process example differs from the above-mentioned process example (see FIG. 9) in the following points.

(Difference 1): the process of step S170c is performed instead of the process of step S170 (see FIG. 9).

(Difference 2): the process of step S230c is performed instead of the process of step S230 (see FIG. 9).

(Difference 3): the processes of steps S510 to S560 are performed after step S260.

(Regarding Difference 1)

The process of step S170c is a process of printing the mirror image (the mirror image 502bi (see FIG. 14B) in the illustrated example) of the other part of the two-dimensional image with the non-photothermal conversion ink and the print barcode 503c (see FIG. 14B) relating to both sides on the second side of the expandable sheet 400. The print barcode 503c (see FIG. 14B) relating to both sides includes information relating to the two-dimensional image 502a (see FIG. 14A) printed on the first side of the expandable sheet 400 in step S140, and information relating to the mirror image 502bi (see FIG. 14B) of the other part of the two-dimensional image printed on the second side of the expandable sheet 400 in step S170c.

(Regarding difference 2)

The process of step S230c is a process of setting the corresponding process for the first side of the expandable sheet 400 based on the information relating to the two-dimensional image 502a (see FIG. 14A) included in the print barcode 503c (see FIG. 14B) relating to both sides. Details of the corresponding process will be described later in “example of corresponding process in this embodiment”.

(Regarding difference 3)

The processes of steps S510 to S560 are as follows.

After step S260, the operator sets the second side of the expandable sheet 400 in the paper feed part 220 (see FIG. 2) of the light irradiation device 200 so that the second side of the expandable sheet 400 is irradiated with light (step S510). In the third modified process example, in step S260, the three-dimensional image 602a corresponding to the two-dimensional image 502a has been formed on the first side of the expandable sheet 400 (see FIG. 14D).

The light irradiation device 200, upon detecting the setting of the expandable sheet 400, reads the print barcode 503c (see FIG. 14B) relating to both sides of the expandable sheet 400 by the barcode reader 340 (see FIG. 2) (step S520), and sends the barcode read information to the control device 100. The light irradiation control means 23 (see FIG. 1) in the control device 100 sets the corresponding process for the second side of the expandable sheet 400, based on the information relating to the mirror image 502bi (see FIG. 14B) of the other part of the two-dimensional image included in the print barcode 503c (see FIG. 14B) relating to both sides (step S530c). Details of the corresponding process will be described later in “example of corresponding process in this embodiment”.

The operator operates the display operation part 150 (see FIG. 1), to instruct the control device 100 to start the light irradiation process. The control device 100 responsively receives the light irradiation process start instruction (step S540).

The light irradiation control means 23 (see FIG. 1) in the control device 100 causes the light irradiation device 200 to execute the light irradiation process (expansion process) based on the set corresponding process, on the second side of the expandable sheet 400 (step S550). As a result, the light irradiation device 200 forms the three-dimensional image 602b corresponding to the mirror image 502bi of the other part of the two-dimensional image, on the first side of the expandable sheet 400 (see FIG. 14F). After the light irradiation process (expansion process) ends, the light irradiation device 200 discharges the expandable sheet 400 (step S560).

In the third modified process example, the operator first sets the first side of the expandable sheet 400 in the paper feed part (not illustrated) of the printer 250 so that the first side of the expandable sheet 400 is printed (step S110). The printer 250 then executes the processes of steps S120 to S180. In step S170c, the printer 250 simultaneously prints the mirror image 502bi of the other part of the two-dimensional image and the print barcode 503c relating to both sides, on the second side of the expandable sheet 400.

After step S180, in step S210, the operator sets the first side of the expandable sheet 400 in the paper feed part 220 of the light irradiation device 200 so that the first side of the expandable sheet 400 is irradiated with light. The light irradiation device 200 then executes the processes of steps S220 to S260. In step S230c, the light irradiation device 200 sets the corresponding process for the first side of the expandable sheet 400, based on the information relating to the two-dimensional image 502a (see FIG. 14A) included in the print barcode 503c (see FIG. 14B) relating to both sides. In step S250, the light irradiation device 200 performs the light irradiation process (expansion process) based on the set corresponding process, on the first side of the expandable sheet 400 (see FIG. 14C). The light irradiation device 200 thus forms the three-dimensional image 602a corresponding to the two-dimensional image 502a, on the first side of the expandable sheet 400 (see FIG. 14D).

After step S260, in step S510, the operator sets the second side of the expandable sheet 400 in the paper feed part 220 of the light irradiation device 200 so that the second side of the expandable sheet 400 is irradiated with light. The light irradiation device 200 then executes the processes of steps S540 to S560. In step S530c, the light irradiation device 200 sets the corresponding process for the second side of the expandable sheet 400, based on the information relating to the mirror image 502bi (see FIG. 14B) of the other part of the two-dimensional image included in the print barcode 503c (see FIG. 14B) relating to both sides. In step S550, the light irradiation device 200 performs the light irradiation process (expansion process) based on the set corresponding process, on the second side of the expandable sheet 400 (see FIG. 14E). The light irradiation device 200 thus forms the three-dimensional image 602b corresponding to the mirror image 502bi of the other part of the two-dimensional image, on the first side of the expandable sheet 400 (see FIG. 14F).

### Fourth Modified Process Example

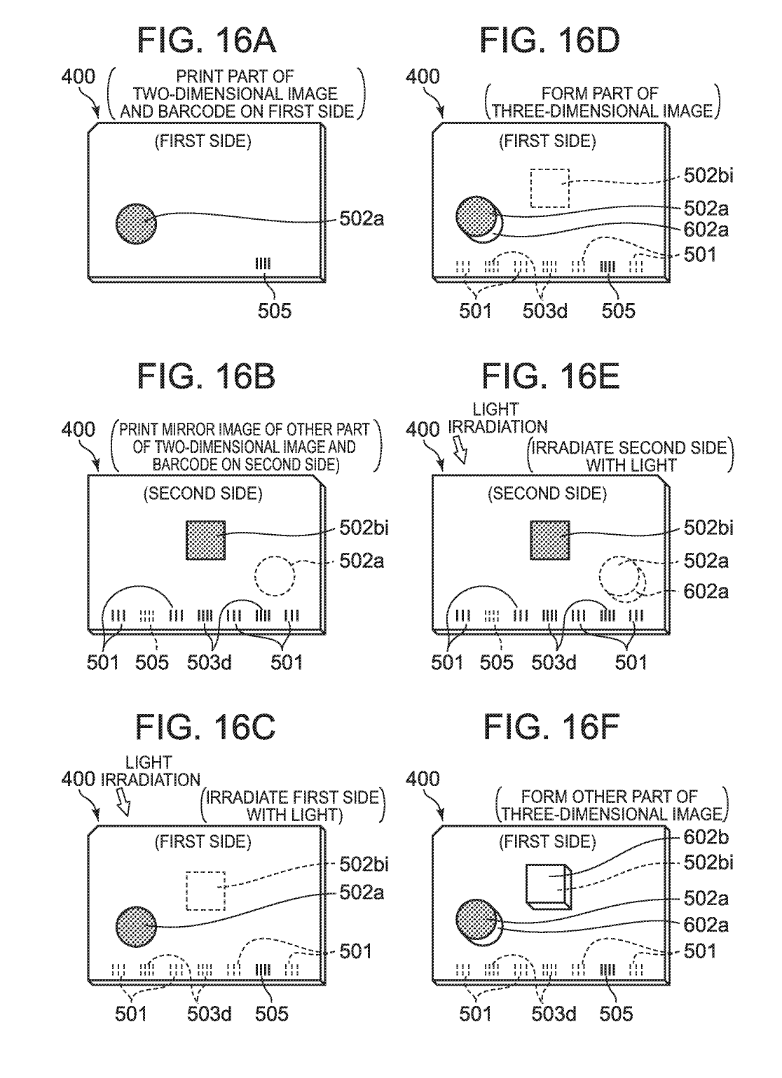

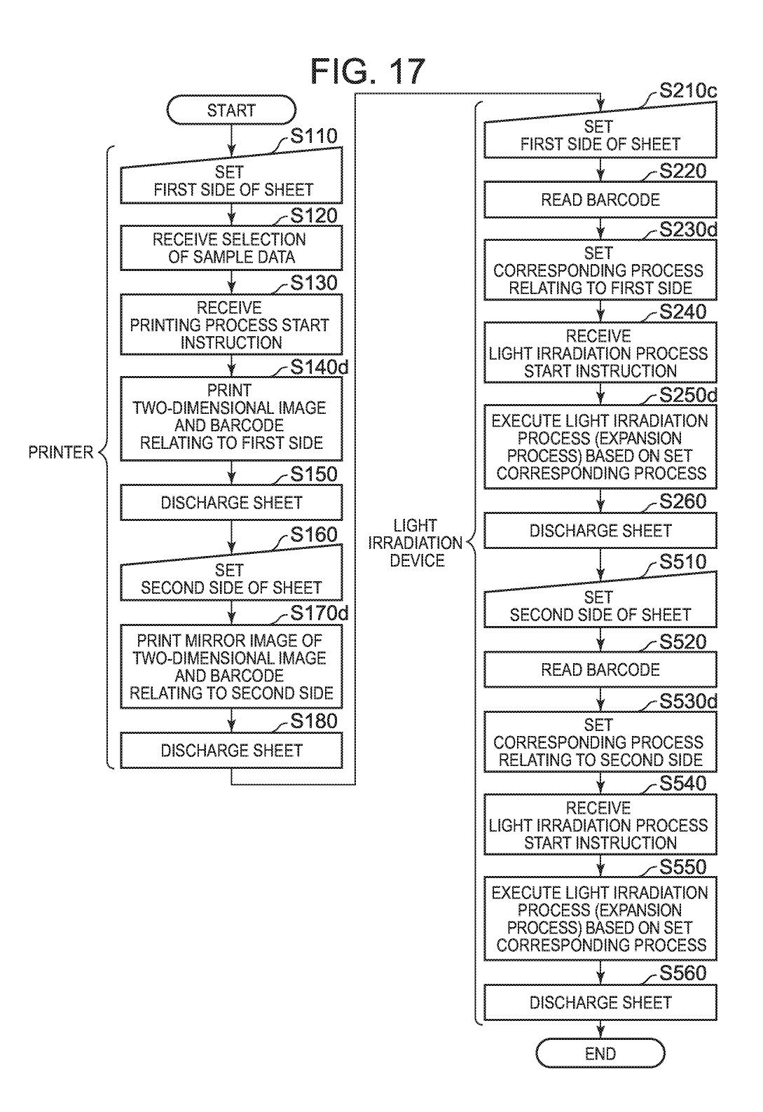

A fourth modified process example is described below, with reference to FIGS. 16A to 17. FIGS. 16A to 16F are diagrams illustrating the fourth modified process example. FIG. 17 is a flowchart illustrating operation of the fourth modified process example.

The fourth modified process example illustrated in FIGS. 16A to 16F indicates that the three-dimensional image formation system 1000 preforms the following processes 4a to 4f.

(Process 4a): print part (the two-dimensional image 502a in the illustrated example) of the two-dimensional image and a print barcode 505 relating to the first side, on the first side (see FIG. 16A). The print barcode 505 relating to the first side includes information relating to the two-dimensional image 502a printed on the first side of the expandable sheet 400.

(Process 4b): print the mirror image (the mirror image 502bi in the illustrated example) of the other part of the two-dimensional image and a print barcode 503d relating to the second side, on the second side (see FIG. 16B). The print barcode 503d relating to the second side includes information relating to the mirror image 502bi of the other part of the two-dimensional image printed on the second side of the expandable sheet 400.

(Process 4c): irradiate the first side with light (see FIG. 16C).

(Process 4d): form part (the three-dimensional image 602a corresponding to the two-dimensional image 502a in the illustrated example) of the three-dimensional image (see FIG. 16D).

(Process 4e): irradiate the second side with light (see FIG. 16E).

(Process 4f): form the other part (the three-dimensional image 602b corresponding to the mirror image 502bi of the other part of the two-dimensional image in the illustrated example) of the three-dimensional image (see FIG. 16F).

The fourth modified process example illustrated in FIGS. 16A to 16F is realized by the three-dimensional image formation system 1000 executing each process in the flowchart in FIG. 17.

As illustrated in FIG. 17, the fourth modified process example differs from the third modified process example (see FIG. 15) in the following points.

(Difference 1): the process of step S140d is performed instead of the process of step S140 (see FIG. 15).

(Difference 2): the process of step S170d is performed instead of the process of step S170c (see FIG. 15).

(Difference 3): the process of step S230d is performed instead of the process of step S230c (see FIG. 15).

(Difference 4): the process of step S530d is performed instead of the process of step S530c (see FIG. 15).

(Regarding Difference 1)

The process of step S140d is a process of, when printing the two-dimensional image (the two-dimensional image 502a in the illustrated example) on the first side of the expandable sheet 400 with the photothermal conversion ink, printing the print barcode 505 relating to the first side on the first side of the expandable sheet 400 with the non-photothermal conversion ink. The print barcode 505 (see FIG. 16A) relating to the first side includes information relating to the two-dimensional image 502a (see FIG. 16A) printed on the first side of the expandable sheet 400 in step S140d, as mentioned above.

(Regarding Difference 2)

The process of step S170d is a process of printing the mirror image (the mirror image 502bi (see FIG. 16B) in the illustrated example) of the other part of the two-dimensional image and the print barcode 503d (see FIG. 16B) relating to the second side on the second side of the expandable sheet 400 with the non-photothermal conversion ink. The print barcode 503d (see FIG. 16B) relating to the second side does not include information relating to the two-dimensional image 502a (see FIG. 16A) printed on the first side of the expandable sheet 400 in step S140d, and includes only information relating to the mirror image 502bi (see FIG. 16B) of the other part of the two-dimensional image printed on the second side of the expandable sheet 400 in step S170d.

(Regarding Difference 3)

The process of step S230d is a process of setting the corresponding process for the first side of the expandable sheet 400 based on the information relating to the two-dimensional image 502a (see FIG. 16A) included in the print barcode 505 (see FIG. 16A) relating to the first side. Details of the corresponding process will be described later in “example of corresponding process in this embodiment”.

(Regarding Difference 4)

The process of step S530d is a process of setting the corresponding process for the second side of the expandable sheet 400 based on the information relating to the mirror image 502bi (see FIG. 16B) of the other part of the two-dimensional image included in the print barcode 503d (see FIG. 16B) relating to the second side. Details of the corresponding process will be described later in “example of corresponding process in this embodiment”.

In the fourth modified process example, in step S140d, the three-dimensional image formation system 1000 prints the two-dimensional image 502a and the print barcode 505 relating to the first side on the first side of the expandable sheet 400 (see FIG. 16A). Moreover, in step S170d, the three-dimensional image formation system 1000 prints the mirror image 502bi of the other part of the two-dimensional image and the print barcode 503d relating to the second side on the second side of the expandable sheet 400 (see FIG. 16B).

In step S230d, the three-dimensional image formation system 1000 sets the corresponding process for the first side of the expandable sheet 400. In step S250, the three-dimensional image formation system 1000 performs the light irradiation process based on the set corresponding process, on the first side of the expandable sheet 400. The three-dimensional image formation system 1000 thus forms the three-dimensional image 602a corresponding to the two-dimensional image 502a printed on the first side, on the first side of the expandable sheet 400 (see FIG. 16D). Next, in step S530d, the three-dimensional image formation system 1000 sets the corresponding process for the second side of the expandable sheet 400. In step S550, the three-dimensional image formation system 1000 performs the light irradiation process based on the set corresponding process, on the second side of the expandable sheet 400. The three-dimensional image formation system 1000 thus forms the three-dimensional image 602b corresponding to the mirror image 502bi of the other part of the two-dimensional image printed on the second side, on the first side of the expandable sheet 400 (see FIG. 16F).

<Example of Corresponding Process in this Embodiment>

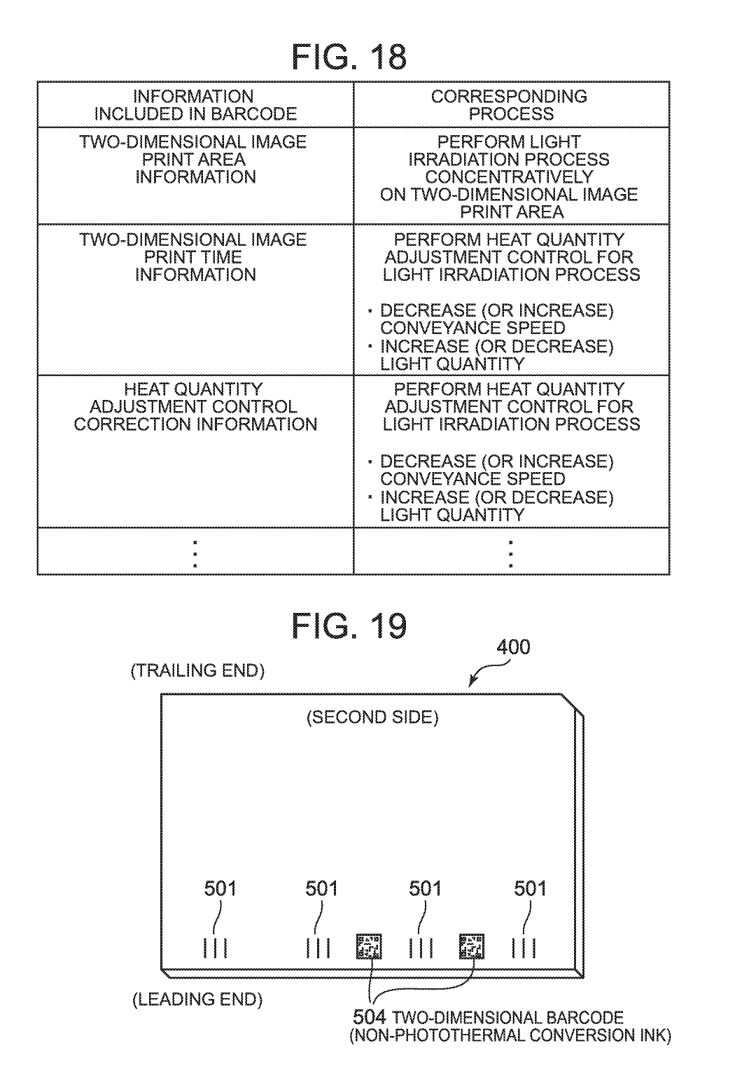

An example of the corresponding process in this embodiment is described below, with reference to FIG. 18. FIG. 18 is a diagram illustrating an example of the corresponding process in this embodiment.

As illustrated in FIG. 18, the print barcode 503 (see FIG. 4B) may include, for example, print area information of the two-dimensional image 502, print time information of the two-dimensional image 502, heat quantity adjustment control correction information, etc., depending on operation.

As an example, suppose the print barcode 503 (see FIG. 4B) includes the print area information of the two-dimensional image 502. In this case, in step S230 (see FIG. 9), the light irradiation control means 23 (see FIG. 1) in the control device 100 sets “perform light irradiation process concentratively on two-dimensional image print area”, as the corresponding process.

As another example, suppose the print barcode 503 (see FIG. 4B) includes the print time information of the two-dimensional image 502, or the print barcode 503 (see FIG. 4B) includes the heat quantity adjustment control correction information. In this case, in step S230 (see FIG. 9), the light irradiation control means 23 (see FIG. 1) in the control device 100 sets “perform heat quantity control for light irradiation process”, as the corresponding process.

Here, “perform heat quantity control for light irradiation process” is set to control the light irradiation device 200 to increase or decrease the quantity of heat applied to the expandable sheet 400 in the light irradiation process.

<Details of Heat Quantity Adjustment Control>

Details of the heat quantity adjustment control are described below.

The heat quantity adjustment control is performed by adjusting (changing) the conveyance speed of the expandable sheet 400, the quantity of light applied to the expandable sheet 400, or the like.

For example, in the case where the two-dimensional image printed on the expandable sheet 400 is an image with which the sufficient expansion height of the three-dimensional image is hard to ensure, the light irradiation device 200 increases the quantity of heat applied to the expandable sheet 400 in the light irradiation process in order to ensure the sufficient expansion height of the three-dimensional image. An image with which the sufficient expansion height of the three-dimensional image is hard to ensure tends to occur in the case where the photothermal conversion ink has not dried sufficiently. For example, in the case where the accumulation density of the photothermal conversion ink used in the printing of the two-dimensional image is high, the accumulation area of the print area where the photothermal conversion ink is printed with certain density or more is large, or the elapsed time from the printing of the two-dimensional image is short, the sufficient expansion height of the three-dimensional image is hard to ensure. For such an image with which the sufficient expansion height of the three-dimensional image is hard to ensure, it is desirable to apply, to the photothermal conversion ink, extra quantity of heat corresponding to the vaporization heat of the photothermal conversion ink, to facilitate drying of the photothermal conversion ink.

Hence, in the case where the two-dimensional image printed on the expandable sheet 400 is an image with which the sufficient expansion height of the three-dimensional image is hard to ensure, the light irradiation control means 23 (see FIG. 1) in the control device 100 sets to decrease the conveyance speed of the expandable sheet 400 or increase the light quantity of the halogen lamp 215 in the light irradiation device 200 as the corresponding process in step S230 (see FIG. 9).

As an example, in the case where the photothermal conversion ink accumulation density is greater than or equal to a threshold, the light irradiation control means 23 (see FIG. 1) in the control device 100 sets a correction amount for decreasing the conveyance speed of the expandable sheet 400. Alternatively, in the case where the photothermal conversion ink accumulation density is greater than or equal to the threshold, the light irradiation control means 23 (see FIG. 1) in the control device 100 sets a correction amount for increasing the quantity of light applied to the expandable sheet 400.

As another example, in the case where the elapsed time from the printing of the two-dimensional image 502 is less than a threshold, the light irradiation control means 23 (see FIG. 1) in the control device 100 sets a correction amount for decreasing the conveyance speed of the expandable sheet 400. Alternatively, in the case where the elapsed time from the printing of the two-dimensional image 502 is less than the threshold, the light irradiation control means 23 (see FIG. 1) in the control device 100 sets a correction amount for increasing the quantity of light applied to the expandable sheet 400.

The light irradiation device 200 then performs the light irradiation process (expansion process) based on the set corresponding process in step S250 (see FIG. 9).

Thus, even in the case where the two-dimensional image printed on the expandable sheet 400 is an image with which the sufficient expansion height of the three-dimensional image is hard to ensure, the three-dimensional image formation system 1000 can facilitate drying of the photothermal conversion ink by applying extra quantity of heat to the photothermal conversion ink. As a result, the three-dimensional image formation system 1000 can ensure the sufficient expansion height of the three-dimensional image.

In the case where the degree of drying of the two-dimensional image printed on the expandable sheet 400 is low, the three-dimensional image formation system 1000 performs heat quantity adjustment control for the light irradiation process in order to apply extra quantity of heat to the photothermal conversion ink to ensure the sufficient expansion height of the three-dimensional image.

Accordingly, in the three-dimensional image formation system 1000, the timing of whether or not to perform heat quantity adjustment control changes depending on whether or not the printing process is performed immediately before the light irradiation process.

(1) For example, suppose the three-dimensional image formation system 1000 prints the photothermal conversion ink only on the first side of the expandable sheet 400, and then performs the light irradiation process on the first side. In this case, the three-dimensional image formation system 1000 performs heat quantity adjustment control for the light irradiation process on the first side.

(2) For example, suppose the three-dimensional image formation system 1000 prints the photothermal conversion ink on the first side of the expandable sheet 400 and then performs the light irradiation process on the first side, and further prints the photothermal conversion ink on the second side of the expandable sheet 400 and then performs the light irradiation process on the second side. In this case, the three-dimensional image formation system 1000 performs heat quantity adjustment control for both of the light irradiation process on the first side and the light irradiation process on the second side.

(3) For example, suppose the three-dimensional image formation system 1000 prints the photothermal conversion ink on both of the first and second sides of the expandable sheet 400, and then performs the light irradiation process on the first side and the light irradiation process on the second side. In this case, the three-dimensional image formation system 1000 performs heat quantity adjustment control for the light irradiation process performed first from among the light irradiation process on the first side and the light irradiation process on the second side.

For example, in the case where the two-dimensional image printed on the expandable sheet 400 is an image with which the sufficient expansion height of the three-dimensional image is easy to ensure, the light irradiation device 200 decreases the quantity of heat applied to the expandable sheet 400 in the light irradiation process, in order to reduce power consumption. An image with which the sufficient expansion height of the three-dimensional image is easy to ensure tends to occur in the case where the photothermal conversion ink has dried sufficiently. For example, in the case where the accumulation density of the photothermal conversion ink used in the printing of the two-dimensional image is low, the accumulation area of the print area where the photothermal conversion ink is printed with certain density or more is small, or the elapsed time from the printing of the two-dimensional image is long, the sufficient expansion height of the three-dimensional image is easy to ensure. For such an image with which the sufficient expansion height of the three-dimensional image is easy to ensure, it is desirable to decrease the quantity of heat applied to the photothermal conversion ink, to reduce power consumption or processing time.

Hence, in the case where the two-dimensional image printed on the expandable sheet 400 is an image with which the sufficient expansion height of the three-dimensional image is easy to ensure, the light irradiation control means 23 (see FIG. 1) in the control device 100 sets to increase the conveyance speed of the expandable sheet 400 or decrease the light quantity of the halogen lamp 215 in the light irradiation device 200 as the corresponding process in step S230 (see FIG. 9).

As an example, in the case where the photothermal conversion ink accumulation density is less than a threshold, the light irradiation control means 23 (see FIG. 1) in the control device 100 sets a correction amount for increasing the conveyance speed of the expandable sheet 400. Alternatively, in the case where the photothermal conversion ink accumulation density is less than the threshold, the light irradiation control means 23 (see FIG. 1) in the control device 100 sets a correction amount for decreasing the quantity of light applied to the expandable sheet 400.

As another example, in the case where the elapsed time from the printing of the two-dimensional image 502 is greater than or equal to a threshold, the light irradiation control means 23 (see FIG. 1) in the control device 100 sets a correction amount for increasing the conveyance speed of the expandable sheet 400. Alternatively, in the case where the elapsed time from the printing of the two-dimensional image 502 is greater than or equal to the threshold, the light irradiation control means 23 (see FIG. 1) in the control device 100 sets a correction amount for decreasing the quantity of light applied to the expandable sheet 400.

The light irradiation device 200 then performs the light irradiation process (expansion process) based on the set corresponding process in step S250 (see FIG. 9). Thus, in the case where the two-dimensional image printed on the expandable sheet 400 is an image with which the sufficient expansion height of the three-dimensional image is easy to ensure, the three-dimensional image formation system 1000 can reduce power consumption or processing time by decreasing the quantity of heat applied to the photothermal conversion ink.

The photothermal conversion ink accumulation density mentioned above means the total amount of ink print density (i.e. the extent of density of printed ink) per one sheet or desired area. In the case where the photothermal conversion ink is ink including carbon black, the two-dimensional image is a gray or black image, so that the density can be expressed as a gray or black level. In the case where the photothermal conversion ink is ink transparent in the visible light region, on the other hand, the two-dimensional image is colorless and transparent, and so the density is a parameter irrelevant to gray or black level.

The above-mentioned correction amount for heat quantity adjustment control varies depending on the image print form in the printer 250. For example, the printer 250 prints the photothermal conversion ink on one of the side of the expandable sheet 400 having the thermal expansion layer 410 (see FIG. 5A) and the side of the expandable sheet 400 not having the thermal expansion layer 410 (see FIG. 5A), prints the photothermal conversion ink on both sides, or prints color ink on one of the sides.

The correction amount varies depending on such an image print form. An appropriate value of the correction amount can be obtained by various experiments.

<Main Features of Three-Dimensional Image Formation System According to this Embodiment>

(1) The three-dimensional image formation system 1000 according to this embodiment includes the printer 250 and the light irradiation device 200. The printer 250 prints, on the expandable sheet 400, the print barcode 503 as an identifier including information relating to the two-dimensional image, before the light irradiation process. The light irradiation device 200 performs a given process (suitable process) depending on the information included in the print barcode 503.

Such a three-dimensional image formation system 1000 enables the expandable sheet 400 to carry information to be notified from the printer 250 to the light irradiation device 200. The three-dimensional image formation system 1000 thus improves convenience.

In the three-dimensional structure produced in the three-dimensional image formation system 1000, the two-dimensional image 502 and the print barcode 503 are printed, and the three-dimensional image is formed. Moreover, in the three-dimensional structure, the preassigned barcode 501 different from the print barcode 503 is printed beforehand. The preassigned barcode 501 is, however, not necessarily essential, and may not be printed beforehand.

(2) In this embodiment, the printer 250 prints the print barcode 503 (see FIG. 4B) including information relating to the two-dimensional image, on the expandable sheet 400. Here, the printer 250 preferably prints the print barcode 503 (see FIG. 4B) near the end of the expandable sheet 400 which is the leading end when setting the expandable sheet 400 in the light irradiation device 200. Near the end of the expandable sheet 400, the preassigned barcode 501 is printed beforehand. The printer 250 prints the print barcode 503 (see FIG. 4B) on the side of the expandable sheet 400 on which the preassigned barcode 501 is printed and at a position away from the preassigned barcode 501.

The print barcode 503 (see FIG. 4B) may include, for example, the print area information of the two-dimensional image 502 printed with the photothermal conversion ink. In this case, the light irradiation device 200 can perform the light irradiation process concentratively on the print area, according to the print area information of the print barcode 503.

The print barcode 503 (see FIG. 4B) may include, for example, the heat quantity adjustment control correction information for the light irradiation process. In this case, the light irradiation device 200 can perform heat quantity adjustment control for the light irradiation process, according to the correction information of the print barcode 503.

The print barcode 503 (see FIG. 4B) may include, for example, the print time information of the two-dimensional image 502 printed in the printer 250. In this case, the light irradiation device 200 can perform heat quantity adjustment control for the light irradiation process, according to the print time information of the print barcode 503.

Since the print barcode 503 is to be read by the light irradiation device 200, the print barcode 503 is printed not with colorless and transparent ink but with color ink with at least certain density. The barcode is preferably not expanded so that the light irradiation device 200 can accurately read the barcode. Therefore, the printer 250 preferably prints the print barcode 503 with the non-photothermal conversion ink having no function of converting light into heat. The printer 250 further preferably prints the print barcode 503 that is visible but has such density that does not cause the expandable sheet 400 to expand.

As described above, the three-dimensional image formation system 1000 according to this embodiment enables the expandable sheet 400 to carry information to be notified from the printer 250 to the light irradiation device 200.

The present invention is not limited to the foregoing embodiment, and various changes and modifications are possible without departing from the scope of the present invention.

The foregoing embodiment has been described in detail to facilitate understanding of the present invention. Therefore, the present invention is not limited to include all of the components described above. The present invention may add one component to another component, or replace one component with another component. The present invention may omit part of the components.

For example, in the foregoing embodiment, the light irradiation device 200 reads the preassigned barcode 501 and the print barcode 503 by the barcode reader 340 (see FIG. 2). Alternatively, the light irradiation device 200 may read the barcode by reading means such as a scanner or a camera, instead of the barcode reader 340 (see FIG. 2).

For example, the print barcode 503 (see FIG. 4B) may be changed to two-dimensional barcode (QR Code®) 504, as illustrated in FIG. 19. FIG. 19 is a diagram illustrating the structure of the two-dimensional barcode 504 as a modification of the print barcode 503. The two-dimensional barcode 504 is printed with the non-photothermal conversion ink, as with the print barcode 503 (see FIG. 4B).

For example, the photothermal conversion ink may be other ink instead of ink including carbon black, as mentioned above. The photothermal conversion ink may be ink that has a function of converting light such as infrared light or near-infrared light into heat and is transparent in the visible light region.

For example, the three-dimensional image formation system 1000 may display, on a display part (not illustrated) provided in the printer 250 or the light irradiation device 200, information (e.g. heat quantity adjustment control correction information) relating to heat quantity adjustment control for the light irradiation process in the light irradiation device 200, and manage the heat quantity adjustment control based on the display information.

For example, in the foregoing embodiment, the printer 250 prints the two-dimensional image 502 only on the first side of the expandable sheet 400. Alternatively, the printer 250 may print the two-dimensional image 502 on the first and second sides of the expandable sheet 400, or print the two-dimensional image 502 only on the second side of the expandable sheet 400. Further, the printer 250 may print a color image on the first side of the expandable sheet 400. The light irradiation device 200 irradiates the first side and/or second side of the expandable sheet 400 with light, depending on such a print form. Here, the light irradiation device 200 performs heat quantity adjustment control.

In the case of printing the color image, the three-dimensional image formation system 1000 performs heat quantity adjustment control depending on the degree of drying of the photothermal conversion ink (the quantity of vaporization heat necessary to dry the photothermal conversion ink).

For example, the light irradiation device 200 may control the light irradiation process based on both of the light irradiation process start time and the time information.

For example, in the foregoing embodiment, the three-dimensional image formation device 290 has a structure of integrating the light irradiation device 200 and the printer 250 (see FIG. 1). Alternatively, the light irradiation device 200 and the printer 250 may be separate from each other. In such a case, the light irradiation device 200 and the printer 250 can be installed independently at different positions.

For example, in the foregoing embodiment, the light irradiation device 200 has the fixed halogen lamp 215, and performs the light irradiation process by conveying the expandable sheet 400 (see FIG. 2). Alternatively, the light irradiation device 200 may have a structure in which the halogen lamp 215 is movable and, in a state where the expandable sheet 400 is held at a fixed position, the halogen lamp 215 in a lighting state is moved to perform the light irradiation process. In view of such a structure, the light irradiation process may involve at least one of control of the light quantity, control of the conveyance speed of the expandable sheet, and control of the moving speed of the light irradiation part for emitting light.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. An image formation system comprising:
a printer that prints an image on an expandable sheet; and
a light irradiation device that performs a light irradiation process on the expandable sheet, to expand the expandable sheet corresponding to a print area of the image,
wherein, before the light irradiation process, the printer prints an identifier including information relating to the image, on the expandable sheet.

2. A three-dimensional image formation system comprising:
a printer that prints a two-dimensional image on an expandable sheet; and
a light irradiation device that performs a light irradiation process on the expandable sheet, to expand the expandable sheet corresponding to a print area of the two-dimensional image and form a three-dimensional image,
wherein, before the light irradiation process, the printer prints an identifier including information relating to the two-dimensional image, on the expandable sheet.

3. The three-dimensional image formation system according to claim 2, wherein the light irradiation device controls the light irradiation process based on the information relating to the two-dimensional image included in the identifier, to expand the expandable sheet corresponding to the print area of the two-dimensional image and form the three-dimensional image.

4. The three-dimensional image formation system according to claim 2, wherein the identifier includes at least one of print area information of the two-dimensional image, print time information of the two-dimensional image, and heat quantity adjustment control correction information for the light irradiation process.

5. The three-dimensional image formation system according to claim 2, wherein the light irradiation process includes at least one of control of a light quantity, control of a conveyance speed of the expandable sheet, and control of a moving speed of a light irradiation part for emitting light.

6. The three-dimensional image formation system according to claim 5, wherein at least one of an increase of the light quantity, a decrease of the conveyance speed of the expandable sheet, and a decrease of the moving speed of the light irradiation part for emitting light is performed (i) in the case where an accumulation density of photothermal conversion ink used in the printing of the two-dimensional image during the printing is high, (ii) in the case where an accumulation area of a print area where the photothermal conversion ink is printed with certain density or more is large, or (iii) in the case where a time from the printing of the two-dimensional image to the light irradiation process is short.

7. The three-dimensional image formation system according to claim 6, wherein the photothermal conversion ink is ink having a property of converting light into heat,
wherein the two-dimensional image is printed with the photothermal conversion ink, and
wherein the identifier is printed with non-photothermal conversion ink which is ink not having the property of converting light into heat.

8. The three-dimensional image formation system according to claim 2, wherein the printer prints the identifier, near an end of the expandable sheet that is a leading end when setting the expandable sheet in the light irradiation device.

9. The three-dimensional image formation system according to claim 8, wherein a preassigned identifier different from the identifier is printed beforehand near the end of the expandable sheet that is the leading end when setting the expandable sheet in the light irradiation device, and
wherein the printer prints the identifier, on a side of the expandable sheet on which the preassigned identifier is printed and at a position away from the preassigned identifier.

10. The three-dimensional image formation system according to claim 2, wherein the light irradiation device controls the light irradiation process, based on both a start time of the light irradiation process and time information.

11. The three-dimensional image formation system according to claim 2, wherein a preassigned identifier different from the identifier is printed beforehand on the expandable sheet, and the preassigned identifier includes information indicating an attribute of the expandable sheet.

12. A three-dimensional image formation method comprising:
a formation step of forming a two-dimensional image on an expandable sheet; and
a light irradiation process step of performing a light irradiation process on the expandable sheet by a light irradiation device, to expand a print area of the two-dimensional image and form a three-dimensional object on the expandable sheet,
wherein the formation step forms an identifier for controlling the light irradiation process and including information relating to the two-dimensional image, on the expandable sheet.

13. The three-dimensional image formation method according to claim 12, wherein after the formation step forms the identifier on the expandable sheet, the light irradiation process step reads the identifier, and controls the light irradiation process based on the information relating to the two-dimensional image included in the identifier, to expand the expandable sheet corresponding to the print area of the two-dimensional image and form a three-dimensional image, and
wherein the control of the light irradiation process includes at least one of control of a light quantity, control of a conveyance speed of the expandable sheet, and control of a moving speed of a light irradiation part for emitting light.

14. The three-dimensional image formation method according to claim 12, wherein the formation step forms the two-dimensional image on the expandable sheet with photothermal conversion ink which is ink having a property of converting light into heat, and prints the identifier on the expandable sheet with non-photothermal conversion ink which is ink not having the property of converting light into heat.

15. A computer-readable storage medium having stored therein a program executable by a computer, the program causing the computer that controls a three-dimensional image formation system for heating an expandable sheet to form a three-dimensional image, to perform:
printing a two-dimensional image on the expandable sheet, and printing an identifier including information relating to the two-dimensional image on the expandable sheet; and
controlling, after the identifier is printed, a light irradiation process by a light irradiation device based on the information relating to the two-dimensional image included in the identifier.

16. The computer-readable storage medium according to claim 15, wherein the light irradiation process includes at least one of control of a light quantity, control of a conveyance speed of the expandable sheet, and control of a moving speed of a light irradiation part for emitting light, based on the information relating to the two-dimensional image included in the identifier.

17. The computer-readable storage medium according to claim 15, wherein the printing prints the two-dimensional image on the expandable sheet with photothermal conversion ink which is ink having a property of converting light into heat, and prints the identifier on the expandable sheet with non-photothermal conversion ink which is ink not having the property of converting light into heat.
